(19) United States
(12) Patent Application Publication
(10) Pub. No.: US 2008/0180463 A1
(43) Pub. Date: Jul. 31, 2008

(54) Display driving device and method, and display device

(75) Inventor: Jun Ogura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/012,158

(22) Filed: Jan. 31, 2008

(30) Foreign Application Priority Data
Jan. 31, 2007 (JP) 2007-020396

(51) Int. Cl. G09G 5/10

(52) U.S. Cl. 345/690

(57) ABSTRACT

A display driving device that drives, based on display data and through a data line, each of a plurality of pixels of different colors, disposed along the data line, connected to the data line and put into a selected state sequentially, comprising: a current generating circuit that generates and outputs a data current which has a current value corresponding to a brightness designated by the display data; and a current control unit that receives the data current that is outputted from the current generating circuit; generates a gradation current, based on the received data current and the display characteristics of each display pixel that is put into the selected state; and supplies, to the data line, the generated gradation current, so that the pixel emits light at the designated brightness based on the display characteristics thereof.

### BACKGROUND OF THE INVENTION

1. Field of the Invention

The present invention relates to a display driving device a display device, and to the driving method thereof, and in particular, relates to a display driving device that drives display pixels comprising current-controlled light emitting elements that emit light in specific brightness gradation levels through supplying currents to the driving device, a display device comprising a display panel wherein the aforementioned display pixels are arrayed in a plurality of rows and columns for displaying an image, and to the driving method thereof.

2. Description of the Related Art

In recent years, organic electroluminescent display panels, which are display panels wherein organic electroluminescent elements, which are self-luminous elements, are arrayed two-dimensionally, have been known as display devices for electronic equipment such as mobile telephones and portable music players.

In particular, when compared to the widely used liquid crystal display devices, organic electroluminescent display panels to which the active matrix drive method has been applied, can provide faster display response speeds, reduced dependency on the viewing angle, increased brightness, heightened contrast, increased display quality and resolution, and so forth. Additionally, organic electroluminescent display panels do not require backlights or light guide plates, as with a liquid crystal display devices, and thus have the superior characteristics that they can be made thinner and lighter. Because of this, organic electroluminescent display panels are anticipated to be applied to a variety of electronic devices in the future.

On the other hand, in recent years mobile telephones, the display is more and more used to display video information (image information), such as still images and videos, and the like, in addition to text information, through the mobile telephones' provision of camera functions and television reception functions. Typically, in this type of video information, there are more curved expressions than there are linear expressions. Because of this, delta arrangements and mosaic arrangements of display pixels are used in display panels used in digital cameras, mobile telephones, and the like.

FIG. 28A and FIG. 28B are schematic diagrams of the critical components illustrating a wiring structure for a display panel when the display pixels are in a delta arrangement.

When the image data is displayed in color, the display pixels that are arranged in the display panel are structured with the three colored pixels of red (R), green (G), and blue (B) as a single set, where, in the delta arrangement, these colored pixels are arranged shifted by a predetermined pixel pitch portion. In regards to the methods for connecting the data lines in this case, there is the so-called “same-color interconnection” method wherein the colored pixels PXp of the same color in each row are connected together by a data line DLp that is disposed in the column direction (the vertical direction in the figure) as shown in, for example, FIG. 28A, and the so-called “different-color interconnection” method wherein, for example, colored pixels PXp are connected by the data lines DLp following a rule such as connecting colors that differ depending on odd versus even rows, for example, as shown in FIG. 28B.

In the same-color interconnections illustrated in FIG. 28A, colored pixels PXp (for example, the green pixels “G”) of identical colors in the delta arrangement in the display panel are connected to a single data line DLp, which is disposed in the column direction in a serpentine pattern. Additionally, in the different-color interconnections illustrated in FIG. 28B, of those colored pixels PXp in the delta arrangement, pixels having two specific colors (for example, green pixels “G” in rows 1 and 3 (odd rows) and blue pixels “B” in rows 2 and 4 (even rows)) are connected to a single data line DLp, which is disposed in the column direction in a serpentine pattern. In FIGS. 28A and B, SLp is a selecting line (scan line) that is disposed in the row direction (in the horizontal direction in the page) of the panel.

Here, when an organic electroluminescent display panel to which an active drive method is applied is used as the display panel described above, typically a structure is used comprising organic electroluminescent elements, which are light emitting elements, as the individual display pixels, along with pixel driving circuits for supplying drive currents (light emitting drive currents) in accordance with the display data. The pixel driving circuits, which will be described in detail below, have a circuit structure comprising a plurality of switching elements (such as thin film transistors).

Because of this, in the case wherein same-color interconnections are applied in a delta arrangement as showed in FIG. 28A, not only the degree of the serpentine pattern of the data line increases significantly, but as display panels become highly miniaturized, the layout design (routing) of the interconnections, such as the wiring within the pixel driving circuits, the data lines, the select lines, and the like, becomes extremely complex and difficult. This reduces the degrees of freedom in the design, and reduces the aperture ratio (the ratio of the light emitting surface area) of each of the display pixels as the interconnection regions are increased in size.

On the other hand, in the case wherein the different-color interconnections are applied in the delta arrangement, the degree of the serpentine pattern for the data lines is reduced, as shown in FIG. 28B, in comparison to the aforementioned same-color interconnections. However, light emitting elements comprising organic electroluminescent elements have different light emitting efficiencies (current efficiencies) depending on the color of the light emission (R, G, or B), so individual gradation signals must be switched in accordance with the respective color pixels (two colors) and supplied to the single data line. Because of this, it is difficult to apply general use current drivers (data drivers), and the driver structures and switching control is more complex, leading to increased product cost.

### SUMMARY OF THE INVENTION

The present invention has the benefit of enabling the provision of a display driving device, a display device, and a driving method thereof, capable of displaying with excellent quality desired image data using general-use current drivers in display panels having an array of pixels of a plurality of colors wherein the data lines are different-color interconnections.

In order to achieve the benefit described above, the display driving device for driving, based on display data and through a data line, each of a plurality of pixels of different colors, disposed along the data line, connected to the data line and put into a selected state sequentially, comprising:

a current generating circuit that generates and outputs a data current which has a current value corresponding to a brightness designated by the display data; and

a current control unit that receives the data current that is outputted from the current generating circuit; generates a gradation current, based on the received data current and the display characteristics of each display pixel that is put into the selected state; and supplies, to the data line, the generated gradation current, so that the pixel emits light at the designated brightness based on the display characteristics thereof.

In order to achieve the benefit described above, the display device for displaying a color image defined by display data, comprising:

a pixel array in which a plurality of scan lines are arranged in a row direction, a plurality of data lines are arranged in a column direction, a plurality of display pixels are arranged and have a plurality of colors, each of the display pixels is connected to respective one of the scan lines and respective one of the data lines and arranged in a neighborhood of an intersection of the respective scan line and respective data line, and the display pixels of at least two different colors of the plurality of colors are connected to each of the data lines;

a scan driving circuit that sets the plurality of display pixels into a selected state by row;

a current generating circuit that generates and outputs a data current which has a current value corresponding to a brightness designated by the display data; and

a current control unit that: receives the data current that is outputted from the current generating circuit; generates a gradation current, based on the received data current and the display characteristics of each display pixel that is put into the selected state by the scan driving circuit; and supplies, to the data line, the generated gradation current, so that the pixel emits light at the designated brightness based on the display characteristics thereof.

In order to achieve the benefit described above, the driving method for a display device for displaying a color image defined display data, wherein:

the display device comprises a pixel array, in which a plurality of scan lines are arranged in a row direction, a plurality of data lines are arranged in a column direction, plurality of display pixels are arranged and have a plurality of colors, each of the display pixels is connected to respective one of the scan lines and one of the data lines and arranged in a neighborhood of the intersection of the respective scan line and respective data line, and the display pixels of at least two different colors of the plurality of colors are connected to each of the data lines;

the driving method comprises:

an operation of setting the plurality of display pixels into a selected state by row;

an operation of generating and outputting a data current which has a current value corresponding to a brightness designated by the display data in accordance with the timing with which the selected state is set;

an operation of receiving the data current; and

an operation of generating, a gradation current, based on the received data current and the display characteristics of each display pixel that is put into the selected state, and supplying through each data line, to the display pixel that is put into the selected state, the generated gradation current, in such a way that the generating and supplying operation is performed in synchronization with the timing with which the display pixel that is connected to each data line is set into the selected state.

### BRIEF DESCRIPTION OF TEE DRAWINGS

FIG. 1 is a schematic block diagram illustrating a first embodiment of a display device according to the present invention.

FIG. 2 is a schematic structural diagram illustrating an example of the critical structures in the display device according to the first embodiment.

FIG. 3 is a block diagram illustrating an example of a current driver that can be applied to the display device according to the first embodiment.

FIG. 4 is a circuit structural diagram illustrating an example of a current control unit that can be applied to the display device according to the first embodiment.

FIG. 5 is a timing chart illustrating an example of a driving control operation in the display device according to the first embodiment.

FIG. 6 is an operation schematic diagram illustrating an operating state (part one) in a current control unit according to the first embodiment.

FIG. 7 is an operation schematic diagram illustrating an operating state (part two) in a current control unit according to the first embodiment.

FIG. 8 is an operation schematic diagram illustrating an operating state (part three) in a current control unit according to the first embodiment.

FIG. 9 is a circuit structural diagram illustrating a specific example of a display pixel that can be applied to a display device according to the present invention.

FIG. 10 is a timing chart illustrating an example of the basic operation in the display pixel according to the first embodiment

FIG. 11A and FIG. 11B are schematic diagrams illustrating the driving control operations for display pixels according to the first embodiment.

FIG. 12 is a circuit structural diagram illustrating a second embodiment of a current control unit that can be applied to a display device according to the present invention.

FIG. 13 is a timing chart illustrating an example of a driving control operation in the display device according to the second embodiment.

FIG. 14 is an operation schematic diagram illustrating an operating state (part one) in a current control unit according to the second embodiment.

FIG. 15 is an operation schematic diagram illustrating an operating state (part two) in a current control unit according to the second embodiment.

FIG. 16 is a schematic block diagram illustrating a third embodiment of a display device according to the present invention.

FIG. 17 is a schematic structural diagram illustrating the critical structures in a display device according to the third embodiment.

FIG. 18 is a circuit structural diagram illustrating an example of a current control unit and a reset circuit unit that can be applied to the display device according to the third embodiment.

FIG. 19 is a timing chart illustrating an example of a driving control operation in the display device according to the third embodiment.

FIG. 20 is a circuit structural diagram illustrating another example of a current control unit and a reset circuit unit that can be applied to the display device according to the third embodiment.

FIG. 21 is a timing chart illustrating an example of a driving control operation in the display device according to the third embodiment.

FIG. 22 is a schematic block diagram illustrating a fourth embodiment of a display device according to the present invention.

FIG. 23 is a schematic structural diagram illustrating the critical structures in a display device according to the fourth embodiment.

FIG. 24 is a circuit structural diagram illustrating an example of a current control unit, a reset circuit unit, and a pixel reset circuit unit that can be applied to the display device according to the fourth embodiment.

FIG. 25 is a timing chart illustrating an example of a driving control operation in the display device according to the fourth embodiment.

FIG. 26 is a circuit structural diagram illustrating another example of a current control unit, a reset circuit unit, and a pixel reset circuit unit that can be applied to the display device according to the fourth embodiment.

FIG. 27 is a timing chart illustrating an example of a driving control operation in the display device according to the fourth embodiment.

FIG. 28A and FIG. 28B are schematic diagrams of the critical components illustrating an interconnection structure for a display panel when the display pixels are in a delta arrangement.

### DETAILED DESCRIPTION OF THE PREFERRED EMBODIMENTS

A display driving device, a display device, and the driving method thereof, according to the present invention, will be described in detail below based on embodiments illustrated in the drawings.

### First Embodiment

### (Display Device)

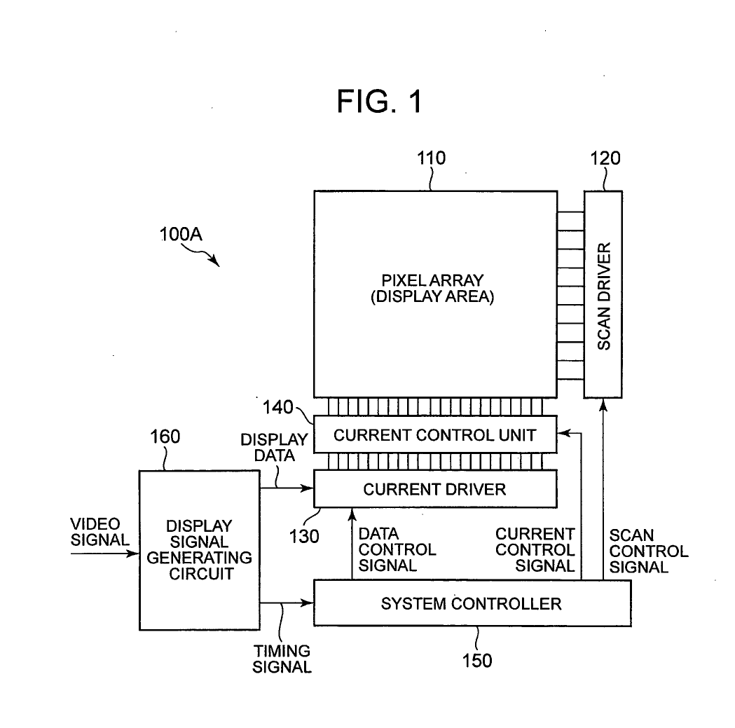

FIG. 1 is a schematic block diagram illustrating a first embodiment of a display device according to the present invention.

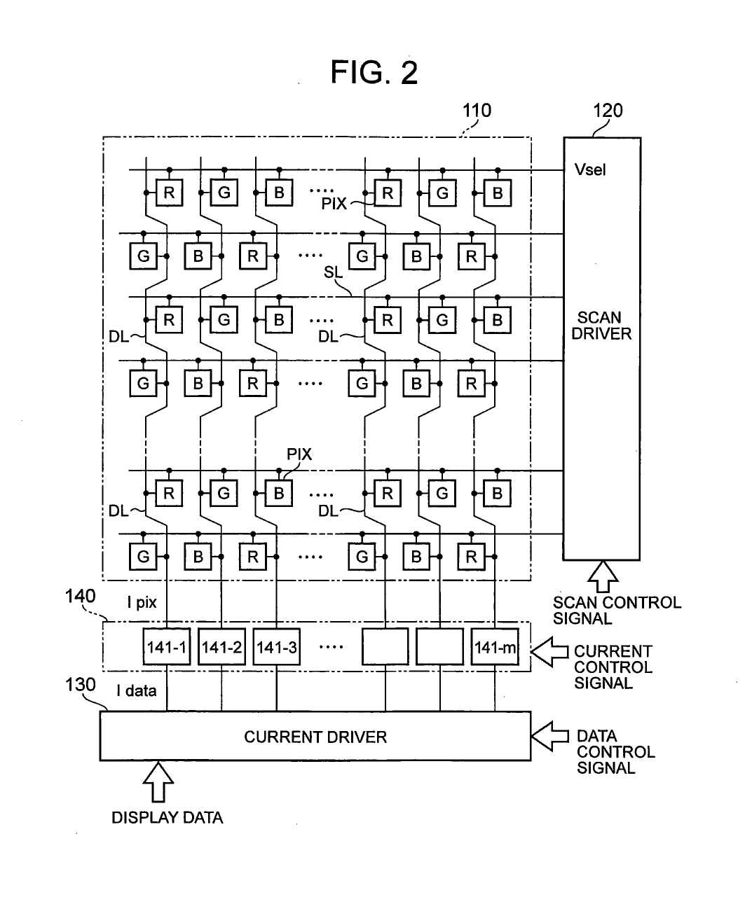

FIG. 2 is a schematic structural diagram illustrating an example of the critical structures (the pixel array and current control unit) in the display device according to the present embodiment.

As illustrated in FIG. 1 and FIG. 2, a display device 100A according to the first embodiment of the present invention basically comprises: a pixel array (display region) 110, a scan driver (scan driver circuit) 120, a current driver (current generating circuit) 130, a current control unit 140, a system controller 150, and a display signal generating circuit 160.

The pixel array 110 is arranged in a delta arrangement of color pixels (display pixels) PIX, in the three colors of red (R), green (G), and blue (B), in n rows and m columns (where n and m are positive integers) in the neighborhood of each of the intersections of a plurality of scan lines SL, arranged in the row direction, and a plurality of data lines DL, arranged in the column direction. The scan driver 120 sequentially sets the color pixels FIX in each row into the selected state through applying a scan signal Vsel, with a specific timing, to each of the scan lines SL. The current driver 130 receives the display data that is supplied by the display signal generating circuit 160, described below, and generates a data current Idata that has a current value in accordance with the brightness gradation value that is included in the display data, and supplies the data current Idata to the current control unit 140, described below. The current control unit 140 is connected to the data line DL for each row and receives the data current Idata in accordance with the display data that is supplied from the current driver 130, described above, converts the data current Idata into a gradation current Ipix, having a current value in accordance with the current efficiency (the light emitting efficiency; display characteristic) of each color pixel PIX, and supplies this gradation current Ipix to each data line DL. Based, for example, on the timing signal that is supplied from the display signal generating circuit 160, the system controller 150 generates and outputs the various control signals (the scan control signal, the data control signal, and the current control signal, and the like) that control the operating states of, at least, the scan driver 120, the current driver 130, and the current control unit 140. Based on, for example, a video signal that is supplied from the outside of the display device 100A, the display signal generating circuit 116 generates and supplies to the current driver 130 display data having brightness gradation values comprising digital data, and generates or extracts, and provides to the aforementioned system controller 150, timing signals (a system clock, or the like) for displaying an image of the display data in the display region that is formed by the pixel array 110.

Each of the structures described above will be explained in detail below.

### (Pixel Array 110)

The pixel array 110 that can be applied to a display device according to the present embodiment is a regular repeating arrangement of color pixels PIX, comprising the three colors of red (R), green (G), and blue (B) in the row direction (in the horizontal direction in the figure) as shown in, for example, FIG. 2, and has a delta arrangement wherein color pixels PIX of the same color in adjacent rows are arranged with an offset from each other equivalent to, for example, 1.5 pixels.

A plurality of scan lines SL is arranged with each scan line SL in the form of a straight line in the row direction (the horizontal direction in the figure), and each is connected to the color pixels PIX that are arranged in the regular RGB sequence described above. On other hand, a plurality of data lines DL is arranged with each in a serpentine pattern in the column direction (the vertical direction in the figure), and each is connected to color pixels PIX that are of different colors in the even rows and the odd rows. In other words, so-called “different-color interconnections,” wherein two colors of color pixels PIX, which are different for each row (for example, red (R) color pixels PIX in rows 1, 3, . . . (2i−1) (where “i” is a positive integer; that is, odd rows) and green (G) color pixels PIX in rows 2, 4, . . . , 2i (that is, even rows)) are connected alternatingly to a single data line DL, is applied to the pixel array 110 according to the present embodiment.

Each color pixel PIX is disposed in the neighborhood of an intersection between a scan line SL and a data line DL, and is connected to the scan line SL and the data line DL that forms the intersection. Additionally, each color pixel PIX is provided with a current-controlled light emitting element, such as an organic electroluminescent element, and a pixel driving circuit that causes the light emitting element to perform a light emitting operation at a desired brightness based on display data (a gradation current). Note that an example of a circuit structure for a color pixel PIX that can be applied in the present embodiment will be described in detail below.

### (Scan Driver 120)

The scan driver 120 sets the color pixels PIX into the selected state, by row, through applying sequentially the scan signal Vsel (for example, the HIGH level) to the scan line SL for each row disposed in the pixel array 110, based on a scan control signal supplied by the system controller 150. By doing so, the scan driver 120 controls the gradation current Ipix, supplied by the current driver 130 and the current control unit 140 through the data line DL for each column, so as to write to the individual color pixels PIX that are set to the selected state row by row.

Here the scan driver 120, although not shown in the figure, is provided, for example, with a shift register circuit that outputs sequentially a shift signal corresponding to the scan line SL for each row based on a scan start signal and a scan clock signal supplied as scan control signals from the system controller 150, described below, and an output circuit (output buffer) that converts the shift signal, which is outputted sequentially from the shift register circuit, to a specific signal level (the select level or the non-select level) and outputs the results as the scan signal Vsel to the scan lines SL for each row based on the output control signal supplied as a scan control signal from the system controller 150.

### (Current Driver 130)

The current driver 130 sequentially and repetitively performs, for each row, the operations of sequentially receiving and latching, with a specific timing for each row, the display data that is supplied from the display signal generating circuit 160, described below, based on a data control signal that is supplied from the system controller 150, generating the data current Idata having a current value in accordance with the brightness gradation value that is included in the display data, and supplying this data current Idata to the current control unit 140 (current value converting circuit unit 140-1, 140-2, . . . 140-m), described below.

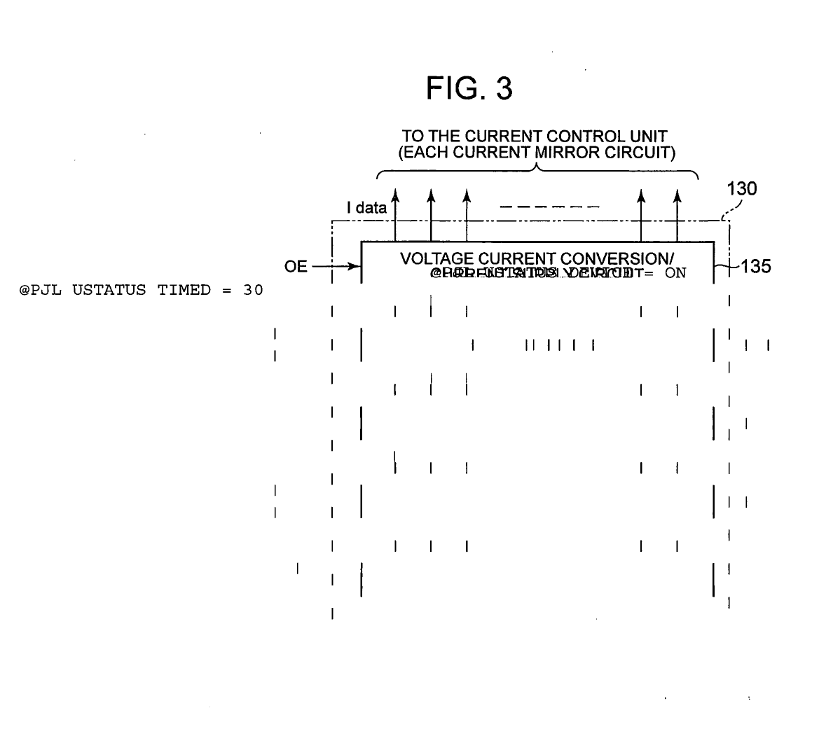

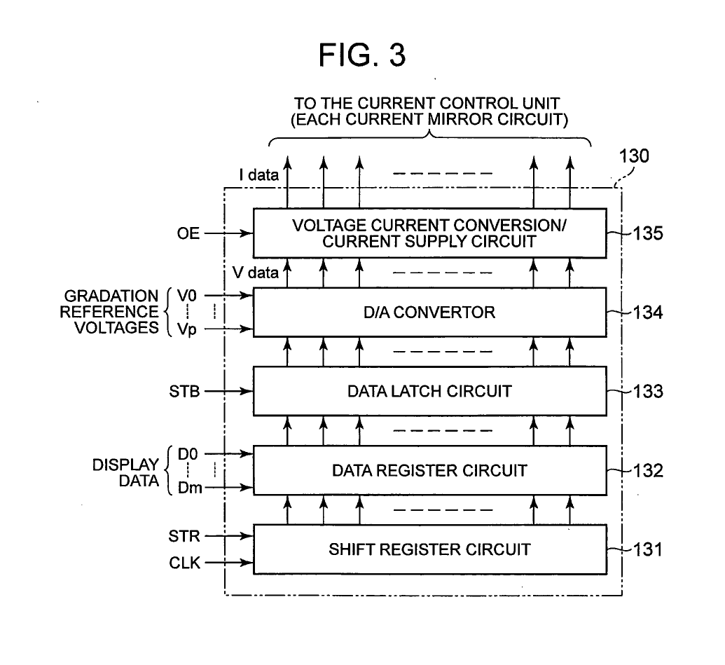

FIG. 3 is a block diagram illustrating an example of a current driver that can be applied to the display device according to the present embodiment.

The current driver 130 comprises, as shown in FIG. 3, for example, a shift register circuit 131, a data register circuit 132, a data latch circuit 133, a digital/analog converter circuit (hereinafter termed “D/A converter”) 134, and a voltage/current converter and current supply circuit 135.

The shift register circuit 131 shifts sequentially a sampling start signal STR and outputs the shift signal, based on a shift clock signal CLK that is supplied as a data control signal from the system controller 150. The data register circuit 132 sequentially receives the brightness gradation values D0 through Dm of display data comprising one line worth of digital data that is supplied from the display signal generating circuit 160 based on the input timing of the shift signal that is outputted from the shift register circuit 131. The data latch circuit 133 latches one row worth of display data D0 through Dm received from the data register circuit 132, based on the data latch signal STB. The D/A converter 134 converts the latched display data D0 through Dm into the respective specific analog signal voltages (data voltages Vdata (Vdata 0 through Vdata m)) based on gradation reference voltages V0 through Vp supplied from a power supply, not shown. The voltage/current converter and current supply circuit 135 generates the respective data currents Idata (Idata 0 through Idata m) having current values in accordance with the brightness gradation values D0 through Dm of the display data, based on the data voltages Vdata, and supplies these simultaneously to the current control unit 140 (the current value converting circuit units 141-1, 141-2, . . . ), described below, based on an output enable signal OE supplied from the system controller 150.

### (Current Control Unit 140)

The current control unit 140 operates based on a current control signal supplied from the system controller 150. The current control unit 140 simultaneously receives, during a first operating period, the data currents Idata Ibased on the brightness gradation values of one row of display data supplied by the current driver 130, and latches these individually in the color pixel PIX for each individual column. The current control unit 140 also supplies simultaneously, through each data line DL to each color pixel PIX, the gradation currents Ipix that have been generated so as to be in accordance with the current efficiencies of each of the color pixels PIX that have been set into the selected state, based on the latched data current Idata, during a second operating period wherein the scan line SL of a specific row has been set into the selected state by the scan driver 120, described above.

During this second operating period, the current control unit 140 also performs an operation that receives, from the current driver 130, and latches data currents Idata for each column, corresponding to the display data for the color pixels PIX for the row that will be set into the selected state during the next operating period, doing so in parallel with the operation for supplying the gradation currents Ipix through each data line DL to each color pixel PIX that has been set to the selected state.

As shown in, for example, FIG. 2, the current control unit 140 establishes the correspondence of the current value converting circuit unit 141-1, 141-2, . . . , 141-m with the data line DL for each column. Each current value converting circuit unit receives and latches the data currents Idata for each column, generated based on the display data by the current driver 130, generates the gradation currents Ipix for each column, having current values in accordance with the data currents Idata for each column and the current efficiencies of the individual color pixels PIX, and supplies these to the individual color pixels PIX through the data lines DL for each column.

### (Specific Circuit Example for Current Control Unit)

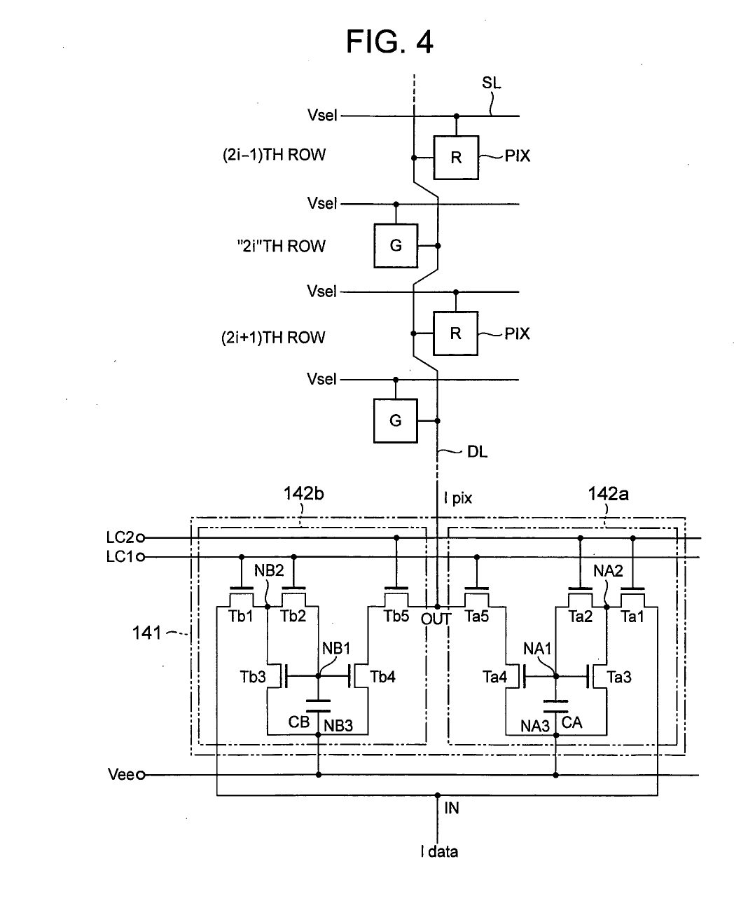

FIG. 4 is a circuit structural diagram illustrating an example of a current control unit (current value converting circuit unit) that can be applied to the display device according to the present embodiment.

Note that only the current control unit (current value converting circuit unit) connected to a data line DL of a specific column (for example, the jth column; where j is any given integer in the range of 1=j=m) disposed in the pixel array 110 is shown here.

Additionally, FIG. 4 is no more than an illustration of one example of a current control unit (current value converting circuit unit) that can be applied to the present embodiment and is not limited to this circuit structure.

The current value converting circuit units 141 (141-1, 141-2, . . . , 141-m shown in FIG. 2) provided corresponding to the data lines DL for each column within the current control unit 140 have, as shown in FIG. 4, one set (one pair) of current latching/converting circuits 142a and 142b, each provided with a current limiter circuit (a current converting circuit). Additionally, in this current value converting circuit unit 141, these current latching/converting circuits 142a and 142b, which comprise a single pair, are connected in parallel to the current driver 130 and data line DL, described above, through an input contact IN and an output contact OUT.

The current latching/converting circuit 142a has a circuit structure, as shown in FIG. 4, for example, comprising: transistors Ta1 and Ta2, the current paths (source-drain) thereof being connected in series between a contact NA1 and the input contact IN, into which the data current Idata from the current driver 130 described above, is inputted; a transistor Ta3, the current path thereof being connected between the contact NA2 of the transistors Ta1 and Ta2 and a contact NA3; transistors Ta4 and Ta5, the current paths thereof being connected in series between the contact NA3 and the output contact (the contact with the data line DL) OUT of the current latching/converting circuit 142a; and a capacitor CA that is connected between the contacts NA1 and NA3.

Here a switching control signal LC1, which is supplied as a current control signal from the system controller 150, is applied to the control terminal (gate) of the transistor Ta5. Furthermore, a switching control signal LC2, which is supplied as a current control signal from the system controller 150, is applied to the control terminals of the transistors Ta1 and Ta2. Additionally, the control terminals of the transistors Ta3 and Ta4 are both connected to the contact NA1, so that the transistors Ta3 and Ta4 form a current mirror circuit. Additionally, a specific low-voltage potential Vee, having a voltage level that is lower than the ground voltage GND, is applied to the contact NA3.

Additionally, as with the current latching/converting circuit 142a, the current latching/converting circuit 142b also has a circuit structure comprising: transistors Tb1 and Tb2, the current paths thereof being connected in series between a contact NB1 and the input contact IN; a transistor Tb3, the current path thereof being connected between the contact NB2 of the transistors Tb1 and Tb2 and a contact NB3; transistors Tb4 and Tb5, the current paths thereof being connected in series between the contact NB3 and the output contact OUT; and a capacitor CB that is connected between the contacts NB1 and NB3.

Here the switching control signal LC1 is applied to the control terminals of the transistors Tb1 and Tb2. Moreover, the switching control signal LC2 is applied to the control terminal of the transistors Tb5. Additionally, the control terminals of the transistors Tb3 and Tb4 are both connected to the contact NB1, so that the transistors Tb3 and Tb4 form a current mirror circuit. Moreover, as with the contact NA3, described above, the low-voltage potential Vee is applied to the contact NB3.

Note that the transistors Ta1, Ta2, and Ta5 provided in the current latching/converting circuit 142a, and the transistors Tb1, Tb2, and Tb5 provided in the current latching/converting circuit 142b, form a contact switching circuit according to the present invention. Moreover the transistor Ta3 and capacitor CA provided in the current latching/converting circuit 142a, and the transistor Tb3 and capacitor CB provided in the current latching/converting circuit 142b, form a current latching circuit according to the present invention.

Additionally, the current ratios between the input currents (the data current Idata) and the output currents (the gradation current Ipix) in the current mirror circuits (the transistors Ta3 and Ta4 and the transistors Tb3 and Tb4), provided in the current latching/converting circuits 142a and 142b, are set depending on the current efficiencies (see below) of the color pixels PIX to which the gradation currents Ipix, which are the output currents of the current value converting circuit units 141 (the current latching/converting circuits 142a and 142b) are applied, so as to be, for example, 1:1 or x:1 (x>1).

Here the individual RGB color pixels that are applied to the color display are known typically to have different brightness, depending on the color of light emitted (different light emitting efficiencies, or in other words, different current efficiencies) when a light emitting drive current having a constant current value is applied to the light emitting elements. Specifically, when a light emitting drive current having a given current value is applied, the blue will have the greatest light emitting brightness, followed by green and then by red with sequentially lower light emitting brightness.

Consequently, when there is a color display using RGB color pixels, it is necessary to convert (correct) the current values of the light emitting drive currents applied to the light emitting elements (or the gradation currents written to each of the color pixels) in order to reconcile the brightness of each of the colors.

As shown in FIG. 2, different-color interconnection, wherein pixels PIX having two different colors are connected to a single data line DL that is disposed in the pixel array 110, is applied to the present embodiment. Because of this, the current ratios that are set in each of the current latching/converting circuits 142a and 142b in a pair provided in the current value converting circuit unit 141 for each column are set so as to be different.

Specifically, as shown in Table 1, when producing a white display, if the maximum brightness gradation values for each of the pixels PIX for R, G, and B (that is, the maximum brightness per unit surface area: cd/m²), are, respectively, LV_{R}, LV_{G}, and LV_{B}, and the current efficiencies (that is, the light emitting brightness per unit current value: cd/A) are, respectively, η_{R}, η_{G}, and η_{B}, then the current values (the current value per unit area: μA/m²) for each pixel at the maximum brightness gradation can be expressed respectively as LV_{R}/η_{R}, LV_{G}/η_{G}, and LV_{B}/η_{B}. Consequently, the current ratios that are set in the current mirror circuits (that is, the ratio of the output current Iout to the input current Iin; Iout:Iin) can be expressed as LV_{R}/η_{R}:1, LV_{G}/η_{G}:1, and LV_{B}/η_{B}:1 for the individual R, G, and B color pixels PIX.

TABLE 1

| | Maximum | | Pixel | |
|---|---|---|---|---|
| | Brightness | Current | Current | |
| | Gradation Value | Efficiency | Value | Current Ratio |
| | (cd/m²) | (cd/A) | (μA/m²) | (Ipix:Idata) |
| Red (R) | LVR | ηR | LVR/ηR | LVR/ηR:1 |
| Green | LVG | ηG | LVG/ηG | LVG/ηG:1 |
| (G) | | | | |
| Blue (B) | LVB | ηB | LVB/ηB | LVB/ηB:1 |

Furthermore, in each of the color pixels PIX for R, G, and B, applied in the present embodiment, the pixel current values at the aforementioned maximum brightness gradations are specified, as shown in Table 2, for example, at, respectively 2.04 μA/m², 0.89 μA/m², and 0.71 μA/m², based on the current efficiencies η_{R}, η_{G}, and η_{B} of the respective color pixels PIX. In this case, the red pixel, which has the largest of the pixel current values (that is, having the smallest current efficiency), is used as a reference, and the current ratios (that is, the ratio of the gradation current Ipix, which is the output current, to the data current Idata, which is the input current) corresponding to each color pixels PIX are set, respectively, to 1:1, 1:2.3, and 1:2.9. Specifically, the transistor size ratios of the transistors Ta3 and Ta4, and of the transistors Tb3 and Tb4, which form the current mirror circuits, for example, are set corresponding to the current ratios. Here, for example, the transistor size is a channel width of each of the transistors in the case where a channel length of each of the transistors is fixed in same size, and the transistor size ratios are ratios of the channel width of each of the transistors.

TABLE 2

| | Pixel Current | Current Ratio |
|---|---|---|
| | Value (μA/m²) | (Ipix:Idata) |
| Red (R) | 2.04 | 1:1 |
| Green | 0.89 | 1:2.3 |
| (G) | | |
| Blue (B) | 0.71 | 1:2.9 |

In this way, the current ratios that are set for the individual current mirror circuits corresponding to the R, G, and B color pixels PIX (the ratio of the gradation current Ipix that is the output current to the data current Idata that is the input current) are set so as to be 1 or less (such that the gradation current Ipix is no more than the data current Idata). Doing so enables the current value of the data current Idata, which is outputted from the current driver 130, to be increased, enabling the D/A converter 134 (shown in FIG. 3), which is provided in the current driver 130, to be fabricated easily.

Note that the capacitors CA and CB, provided in the individual current latching/converting circuits 142a and 142b, may be the parasitic capacitances that are formed between the gates and the drains of the respective transistors Ta3 or Ta4 and Tb3 or Tb4. Additionally, each of the transistors Ta1 through Ta5, and Tb1 through Tb5, which constitute the individual current value converting circuit units 141 (the current latching/converting circuit 142a and 142b), may use an n-channel field effect transistor using, for example, and amorphous silicon semiconductor or a polysilicon semiconductor as the channel layer.

Here there is a problem area in that there tends to be a change over time in the element characteristics (the threshold voltage, and the like) of amorphous silicon transistors. However, when a field effect transistor provided with an amorphous silicon semiconductor is used as the current value converting circuit unit 141 (the current latching/converting circuits 142a and 142b) according to the present embodiment, fabricating proximally the pair of transistors Ta3 and Ta4 and the pair of transistors Tb3 and Tb4 that structure the current mirror circuits can cause the degrees of advancement in the change (degradation) of the characteristics of these transistors to be equal to each other. Additionally, because it is possible to control the operating state by a single gate voltage (the voltage of contact NA1 or NB1), it is also possible to perform extreme control of the effects of the change in characteristics on the operation of the current mirror circuits (the current value of the gradation current Ipix relative to the data current Idata) and, further, on the display quality.

That is, in the current control unit 140 (the current value converting circuit unit 141) in the present embodiment, the current mirror circuit and the current driver 130 are connected in either the current latching/converting circuit 142a or 142b based on the switching control signal LC1 or LC2, which are of mutually opposite phases, supplied as current control signals from the system controller 150 (at which time, the current mirror circuit and the data line DL are set to a non-connected state), so that the data current Idata that is supplied from the current driver 130 will be received. At the same time, on the other side, the current mirror circuit and the data line DL are connected (at which time, the current mirror circuit and the current driver 130 are set into a non-connected state), so that the current that flows on the output side of the current mirror circuit is supplied to the specific color pixel PIX through the data line DL as the gradation current Ipix. Note that a specific control operation for the current control unit 140 will be explained in detail in the driving method of the display device, described below.

### (System Controller 150)

The system controller 150 supplies, to the scan driver 120, the current driver 130, and the current control unit 140, a scan control signal, a data control signal, and a current control signal, which control the operating status, to thereby perform, with the respective specific timings, the operations of generating and applying to the scan line SL a scan signal Vsel in the scan driver 120, generating the data current Idata in accordance with the display data in the current driver 130, and converting the data current Idata to generate the gradation current Ipix, which is supplied to the data line DL, in the current control unit 140. In this way, the system controller 150 controls the display of the specific image information, based on the video signal, onto the pixel array 110 by writing the display data to the individual color pixels PIX to cause light emitting operations at the appropriate brightness gradations.

### (Display Signal Generating Circuit 160)

The display signal generating circuit 160 extracts the signal component that includes the brightness gradation value from the video signal that is supplied from the outside of the display device 100A, for example, and supplies that signal component to the current driver 130 as the display data for each row in the pixel array 110. If this video signal includes a timing signal component that specifies the display timing of the image data, such as in a television broadcast signal (a component video signal) then the display signal generating circuit 160 has, in addition to the function for extracting the signal component that includes the brightness gradation value, a function for extracting the timing signal component and supplying it to the system controller 150. In this case, as shown in FIG. 1, the system controller 150, generates the various types of control signals that are supplied to the scan driver 120, the current driver 130, and the current control unit 140, based on the timing signals that are supplied by the display signal generating circuit 160.

### (Display Device Driving Method)

Next the driving method in the display device described above will be explained in reference to the figures.

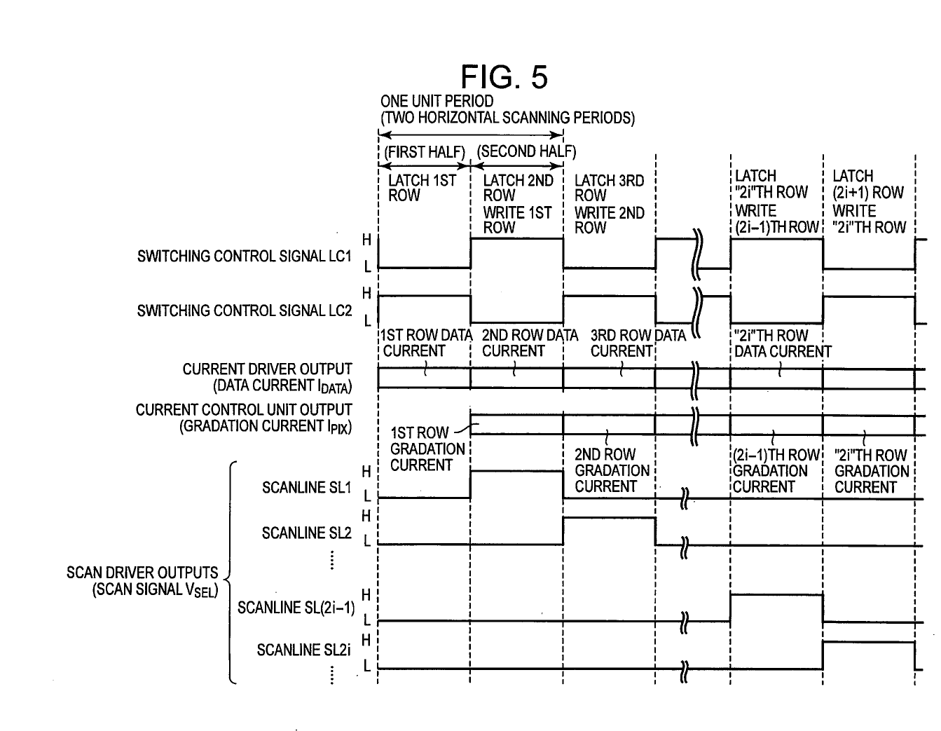

FIG. 5 is a timing chart illustrating an example of a driving control operation (the driving method) in the display device according to the present embodiment.

Here, a specific description will be given regarding the latching operation and writing operation for display data for color pixels PIX of the odd number (2i−1) rows and of the even number (2i) rows (where “i” is a positive integer fulfilling 1=2i−1=n−1, and 2=2i=n), for the case wherein the pixel array 110 is a pixel array of n rows by m columns (where n is an odd number and m is a multiple of 3), as described above.

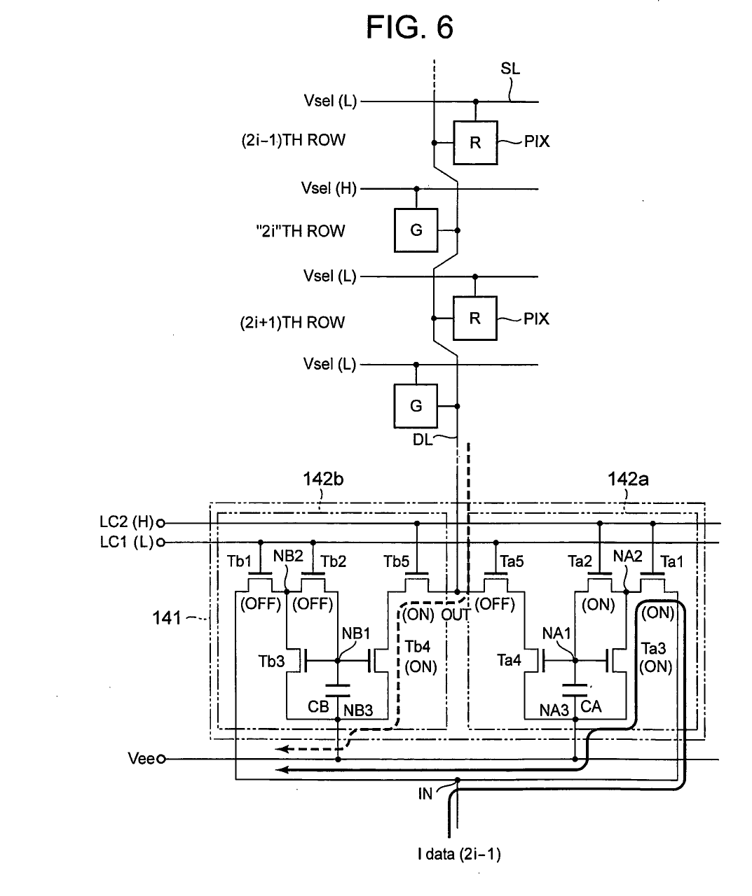

Moreover, FIG. 6 through FIG. 8 are operation schematic diagrams illustrating the operating states in a current control unit (current value converting circuit unit) according to the present embodiment

The driving control operation in the display device 100A in the present embodiment includes a current latching operation that is performed during a first-half of one horizontal scan period (a current latching operation period) and a current writing operation that is performed during a second-half of one horizontal scan period (a current writing operation period), with two horizontal scan periods wherein two adjacent rows of color pixels PIX are selected sequentially is defined as one unit period. Here the current latching operation is the operation wherein the data current Idata that is in accordance with the brightness gradation value of the display data for one row, supplied from the current driver 130, is received by, and maintained in, one of the pair of current latching/converting circuits 142a and 142b of the current value converting circuit unit 141 that is provided for each column of the current control unit 140. Moreover, the current writing operation is the operation that generates the gradation current Ipix that has a specific current ratio, shown in Table 1 or Table 2 described above, relative to the data current Idata that is received by either the current latching/converting circuit 142a or 142b in the current latching operation described above, and writes this gradation current Ipix to each of the color pixels PIX in the specific row.

Here the aforementioned current latching operation and current writing operation are performed in a synchronized manner between the pair of current latching/converting circuits 142a and 142b that form the current value converting circuit unit 141, and are controlled so as to be repeatedly performed alternatingly.

In other words, during the period wherein the data current Idata that is supplied corresponding to each data line DL from the current driver 130 based on the display data is received and held by one of the current latching/converting circuit sides (for example, the current latching/converting circuit 142a) of the air of current latching/converting circuits 142a and 142b that form one of the current value converting circuit units 141, the gradation current Ipix corresponding to the data current Idata that was received and latched with the timing of the immediately preceding reception is supplied, simultaneously and in parallel, to each data line DL from the current latching/converting circuit on the other side (for example, the current latching/converting circuit 142b). Because of this, as will be described below, an operation is performed wherein the gradation current Ipix is generated substantially continuously based on the display data from the display driver 130 and the current control unit 140, and supplied to the data lines DL for each column.

Specifically, during a first operating period (the first-half of one horizontal scan period, when two horizontal scan periods is defined as a unit period) in the current value converting circuit units 141 that are provided for each column in the current control unit 140, described above, when, as shown in FIG. 5 and FIG. 6, the switching control signal LC1 that is supplied as a current control signal from the system controller 150 is at the LOW level (L) and the switching control signal LC2 is at the HIGH level (H), the transistors Ta1 and Ta2 of the current latching/converting circuit 142a will turn ON, and the transistor Ta5 will turn OFF

Additionally, the data current Idata that corresponds to the display data for the color pixels PIX in each column for a specific row (such as row (2i−1)) is supplied from the current driver 130, synchronized with this timing. When this is done, there is electrical shorting between the gate and the drain of the transistor Ta3, which turns ON in the saturation region, so the data current Idata flows in the direction of the low-voltage potential Vee through transistors Ta1 and Ta3 and contact NA3. At this time, the current level of the data current Idata will be converted into a voltage level (the voltage component) across the gate and source of the transistor Ta3, which is stored as an electrical charge in the capacitor CA (the current latching operation).

At this time, the potential at contact NA1 will increase according to the charge that is stored in the capacitor CA, causing the transistor Ta4, which forms the current mirror circuit together with the transistor Ta3, to turn ON, but because the transistor Ta5 is set to the OFF state, no current flows in the transistor Ta4.

In this way, in the current latching operation, the data current Idata that is outputted for each column depending on the brightness gradation level that is included in the display data from the current driver 130 flows to the current latching/converting circuit 142a, equipped on one side in each of the current value converting circuit units 141, so that the data current Idata (2i−1) for one row (for example, row (2i−1)) will be received by, and latched in, the current control unit 140.

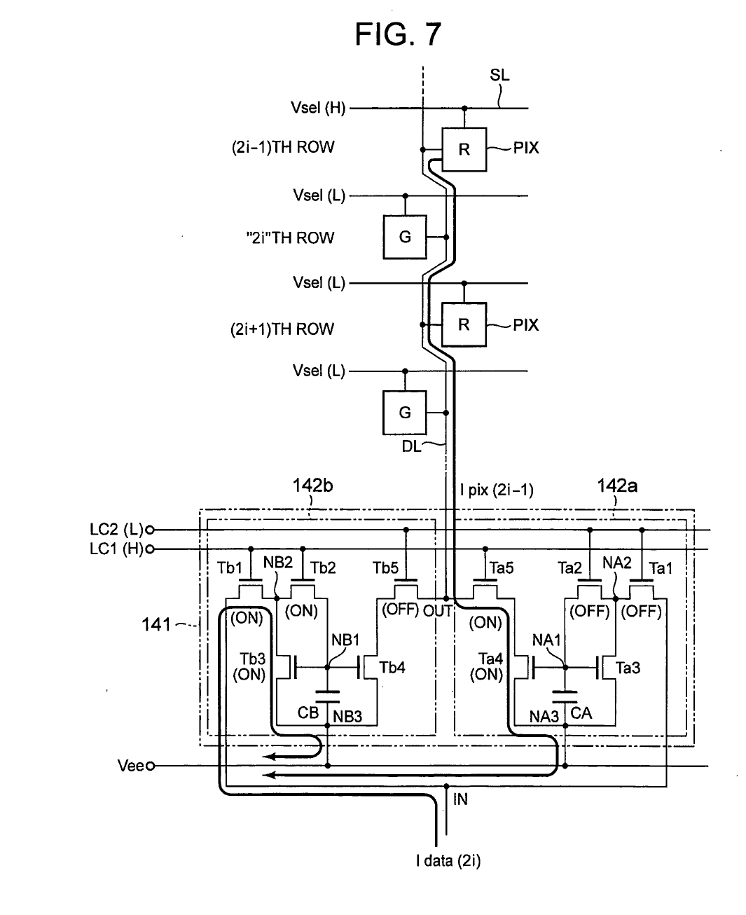

Next, during a second operating period (the second-half of one horizontal scan period, when two horizontal scan periods is defined as a unit period), when, as shown in FIG. 5 and FIG. 7, the switching control signal LC1 that is supplied as a current control signal from the system controller 150 is at the HIGH level (H) and the switching control signal LC2 is at the LOW level (L), the transistors Ta1 and Ta2 of the current latching/converting circuit 142a will turn OFF, and the transistor Ta5 will turn ON.

At this time, a potential (high voltage) will be maintained at the contact NA, given the current latching operation described above (FIG. 6), based on the charge that is stored in the capacitor CA, so the transistor Ta4 will remain ON. Because of this, the data line DL will be connected to the current latching/converting circuit 142a through the output contact OUT, and a gradation current Ipix will flow, having a current value based on the charge stored in the capacitor CA (that is, based on the data current Idata), so as to be drawn from the data line DL side towards the low-voltage potential Vee through the transistors Ta5 and Ta4.

Additionally, synchronized with this timing, a scan signal Vsel of the select level (HIGH level) will be applied to the scan line SL of the row to which the display data is being written by the scan driver 120, to set into the selected state the other pixels PIX of the applicable row. Doing so causes the gradation current Ipix, described above, to flow so as to be extracted in the direction of the current control unit 140 through each data line DL so that, as described below, a charge (voltage component) that is in accordance with the gradation current Ipix will be stored in the pixel driving circuit that is provided for the individual color pixels PIX (current writing operation).

Here, in the current writing operation to the color pixels PIX by the current control units 140, the current value for the data current Idata in accordance with the brightness gradation value of the display data for the applicable color pixel PIX will be converted (corrected) into the current value in accordance with the current efficiency of the color pixel PIX, according to the current ratio set in the current mirror circuit (the transistors Ta3 and Ta4), set in the current latching/converting circuit 142a, to flow to each color pixel PIX as the gradation current Ipix.

In this way, in the current writing operation, the gradation current Ipix is extracted from the color pixels PIX of the row that is set to the selected state (for example, row (2i−1)) by the current latching/converting circuit 142a, provided on one side of each of the current value converting circuit units 141, to which the data current Idata is supplied by the current latching operation described above. Because of this, one row worth of gradation current Ipix (2i−1) is written to, and latched in, the individual color pixels PIX (the red (R) color pixel in the example in FIG. 7) in accordance with the current ratios for the individual color pixels and in accordance with the brightness gradation values of the display data.

Furthermore, in the current latching/converting circuit 142a that is provided in the other side of this type of current value converting circuit unit 141, during the period of the current writing operation wherein the specific gradation currents Ipix are extracted through the data line from the color pixels PIX that are set to the selected state, the switching control signal LC1 that is supplied as a current control signal from the system controller 150 is set to the HIGH level (H) and the switching control signal LC2 is set to the LOW level (L), as shown in FIG. 5 and FIG. 7. Because of this, the transistors Tb1 and Tb2 in the other current latching/converting circuit 142b that is provided in the current value converting circuit unit 141 are turned ON and the transistor Tb5 is turned OFF.

Additionally, the data current Idata that corresponds to the display data for the color pixels PIX in each column for the next row (such as row 2i) is supplied from the current driver 130, synchronized with this timing. As a result, as with the case of the current latching operation in the one current latching/converting circuit 142a, described above, the data current Idata (2i) flows in the direction of the low-voltage potential Vee through transistors Tb1 and Tb3, and the contact NB3, so that a voltage component in accordance with the applicable data current Idata will be stored in the capacitor CB that is connected across the gate and source of the transistor Tb3 (current latching operation).

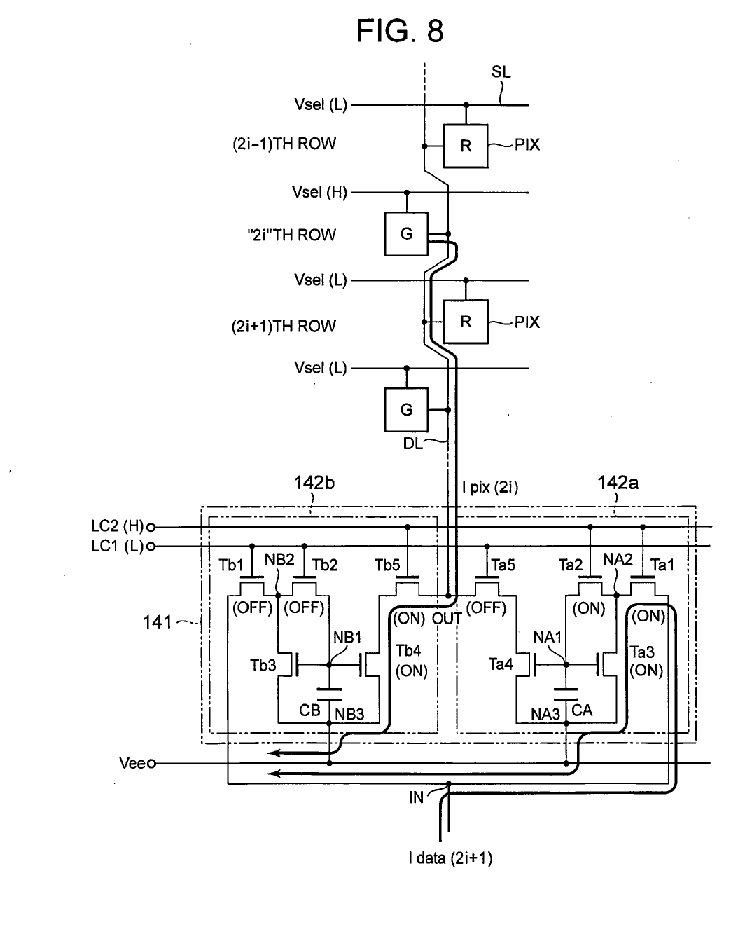

Next, during a third operating period (the first-half of one horizontal scan period, when two horizontal scan periods is defined as a unit period; the same as for the first operating period described above), as shown in FIG. 5 and FIG. 8, the switching control signal LC1 that is supplied as a current control signal from the system controller 150 is again set to the LOW level (L) and the switching control signal LC2 is again set to the HIGH level (H). Because of this, the transistors Tb1 and Tb2 in the current latching/converting circuit 142b are turned OFF and the transistor Tb5 is turned ON.

Because of this, the gradation current Ipix, which has a current value that is based on the charge that was stored in the capacitor CA by the current latching operation (FIG. 7), described above, flows so as to be drawn in the direction of the low-voltage potential Vee from the data line DL side through the transistors Tb5 and Tb4. By the scan driver 120 setting into the selected state the next row of color pixels PIx, synchronized with this timing, the gradation currents Ipix (2i) are extracted through the data lines DL from the individual color pixels PIX (the green (G) color pixels in FIG. 8), and charges (voltage components) are maintained (the current writing operation)

In this way, during the period wherein the current writing operation that supplies the gradation current Ipix to the color pixel PIX in the odd (2i−1) row is performed in the one current latching/converting circuit 142a of the current value converting circuit unit 141, the current latching operation, which receives and latches the data current Idata in accordance with the color pixel PIX for the even (2i) row, is performed simultaneously in the other current latching/converting circuit 142b. Moreover, during the period wherein the current writing operation that supplies the gradation current Ipix to the color pixel PIX in the even (2i) row is performed in the other current latching/converting circuit 142b, the current latching operation, which receives and latches the data current Idata in accordance with the color pixel PIX for the odd (2i+1) row, is performed simultaneously in the first current latching/converting circuit 142a.

The display device according to the present embodiment comprises a pixel array wherein the individual RGB pixels are arranged in a delta arrangement having different-color interconnections wherein color pixels having two different colors are connected regularly to each data line disposed in the column direction, and comprises a current driver for generating a data current having a current value in accordance with the brightness gradation value included in the display data for each color pixel in the individual column, and a current control unit for converting the data current that is generated for each pixel in the individual column into a current value in accordance with a current ratio for each color pixel, and outputting the current value, as a gradation current, through the data line DL for the individual column. Because of this, it is possible to convert the current values for the data currents that are outputted from the current driver for pixels of different colors that are connected to the data line, doing so in accordance with the current efficiencies (light emitting efficiencies) of each color pixel. Consequently, it is possible to use, without modification, existing current drivers (data drivers) that generate and output data currents having current values that are in accordance with only the brightness gradation values that are included in the display data.

Furthermore, a current value converting circuit unit comprising a set (a pair) of current mirror circuits (current latching/converting circuits) formed in advance so as to have a current ratio in accordance with the current efficiencies of the color pixels of different colors that are connected to the individual data line is used as a structure for converting data currents that are in accordance with only the brightness gradation values of the display data that are outputted from the current driver, as described above, into gradation currents that have current values that are in accordance with the current efficiencies of the color pixels. Additionally, these enable the use of a simple control method for repeatedly alternating a current latching operation and a current writing operation. Because of this, it is possible to maintain a temporal margin in the switching control timing of the output current in the writing operation of the gradation signal to the color pixels in each row, enabling the display of desired image data, such as video images, with excellent image quality.

As a result, the provision of a plurality of current drivers (data drivers) corresponding to the individual color pixels is not necessary in a display device that is provided with a pixel array wherein the color pixels are arranged in a delta arrangement with different-color interconnections. Moreover, this enables gradation currents to be generated and outputted to data lines for the individual color pixels using a simple control method. Because of this, it is possible not only to prevent increased complexity of the display device, the driver structure, and the control method, but also to prevent increases in product costs.

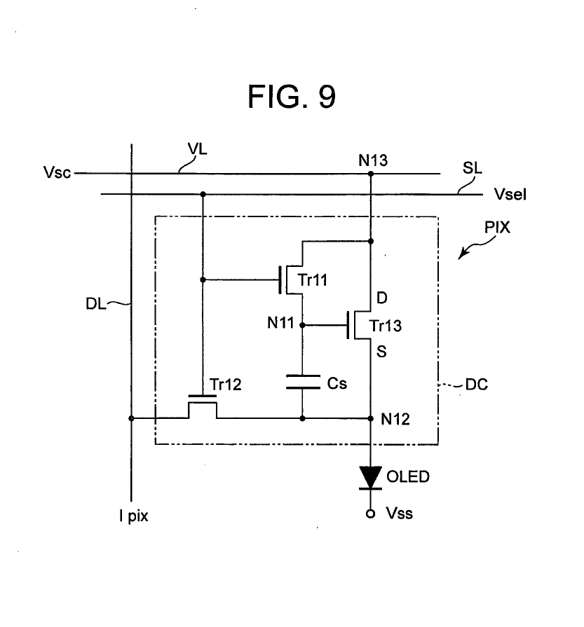

Note that in the current control unit 140 according to the resent invention, a case was described wherein, in order to accommodate the circuit structures of the pixel driving circuits provided for the pixels PIX (shown in FIG. 9), described below, there was a function that generated a gradation current Ipix having a negative polarity corresponding to the data current Idata of a positive polarity supplied from the current driver 130, so that the gradation current Ipix flowed in a direction that was drawn (was extracted) from the data line DL (pixel PIX) side. However, the present invention is not limited thereto, but rather may have a structure wherein a gradation current Ipix with a positive polarity is generated depending on the circuit structure for the color pixel PIX to cause the gradation current Ipix to flow in the direction of pushing into the data line DL (the color pixel PIX).

Note that the majority of the well-known current drivers (data drivers) that are commonly distributed in the market today, and that can be obtained easily, have structures that output the current (the data current Idata) with a positive polarity. Because of this, the use of the current control unit 140 and the color pixels PIX (pixel driving circuits) as described above enables the achievement, using well-known current drivers, of a display driving device wherein the gradation current flows in the draw-down direction in the current control 140 direction.

Moreover, in the display device according to the present embodiment, as shown in FIG. 2, a case was explained wherein a pixel array was provided wherein the color pixels were arranged in a delta arrangement. However, the present invention is not limited thereto, but rather the arrangement may be, for example, a mosaic arrangement, and the current control unit 140, as described above, may be used appropriately insofar as there is a pixel array wherein color pixels having a plurality of different colors are connected regularly to a single data line.

Moreover, the pixel array comprised pixels of the three colors of red, green, and blue, wherein color pixels of two different colors were connected to a single data line. However, the present invention is not limited thereto, but instead the pixel array may comprise color pixels of more than three colors, such as color pixels of four colors or more. Moreover, there may be color pixels of more than two colors, for example color pixels of three colors or more, connected regularly to a single data line.

### (Specific Circuit Example for Display Pixel)

Next a specific circuit example for a display pixel that can be used in the display device set forth in the embodiment described above will be explained in reference to the figures.

FIG. 9 is a circuit structural diagram illustrating a specific example of a display pixel (pixel driving circuit and light emitting element) that can be applied to the display device according to the present embodiment.

As shown in FIG. 9, the color pixel (display pixel) PIX that can be applied to the display device according to the present embodiment comprises a pixel driving circuit DC and a light emitting element. The pixel driving circuit DC sets the selected state of the color pixel PIX based on the scan signal Vsel that is applied by the scan driver 120, described above, and in the selected state, receives, and latches as a voltage component, the gradation current Ipix that is supplied from the current control unit 140, so that a light emitting driving current will flow to the light emitting element in accordance with the gradation current Ipix. The light emitting element is a current-controlled light emitting element, such as an organic electroluminescent element OLED, or the like, that operates so as to emit light at a specific brightness gradation based on the light emitting driving current that is applied by the pixel driving circuit DC.

The pixel driving circuit DC, as shown in, for example, FIG. 9, comprises a transistor Tr11, the control terminal (the gate terminal) thereof connected to the scan line SL, and the current path (the source-drain) thereof connected to a contact N11 and a power supply line VL (contact N13), to which is applied a power supply voltage Vsc is applied; a transistor Tr12 wherein the control terminal thereof is connected to the scan line SL and the current path thereof is connected to the data line DL and a contact N12; a transistor Tr13 wherein the control terminal thereof is connected to the contact N11 and the current path thereof is connected to the power supply line VL and the contact N12; and a capacitor Cs that is connected between the contact N11 and the contact N12.

The organic electroluminescent element OLED is connected with the anode terminal thereof connected to the contact N12 of the aforementioned pixel driving circuit DC, and the cathode terminal thereof is connected to Vss (for example, the ground potential).

Here n-channel thin film transistors (field effect transistors) can be used for any of the transistors Tr11 through Tr13. Additionally, the capacitor Cs is the parasitic capacitance that is formed between the gate and the source of the transistor Tr13, or has a supplemental capacitance that is added between the gate and the source.

(Driving Control Operation for Display Pixel)

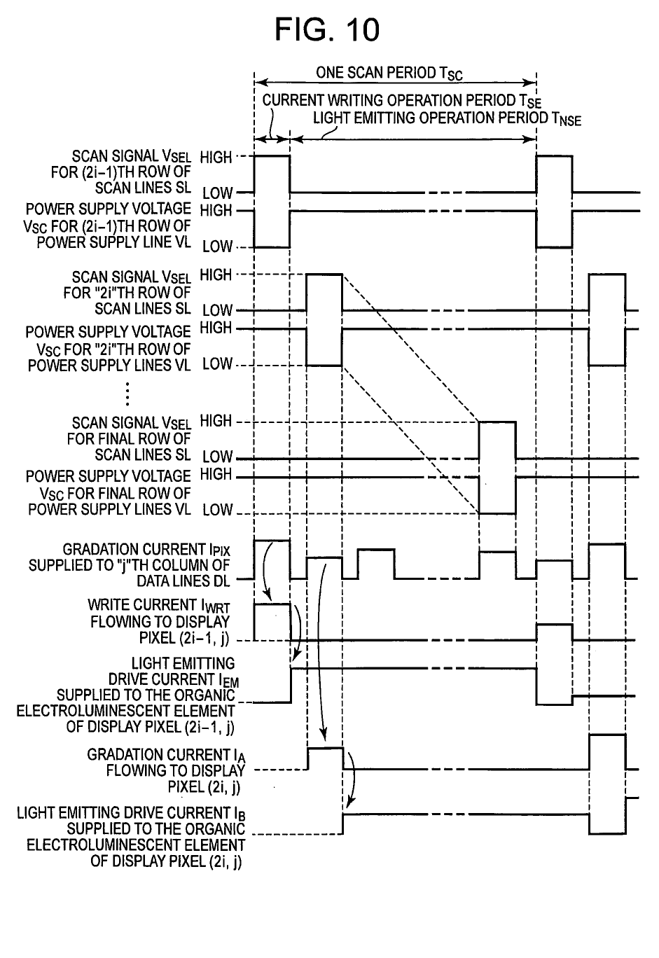

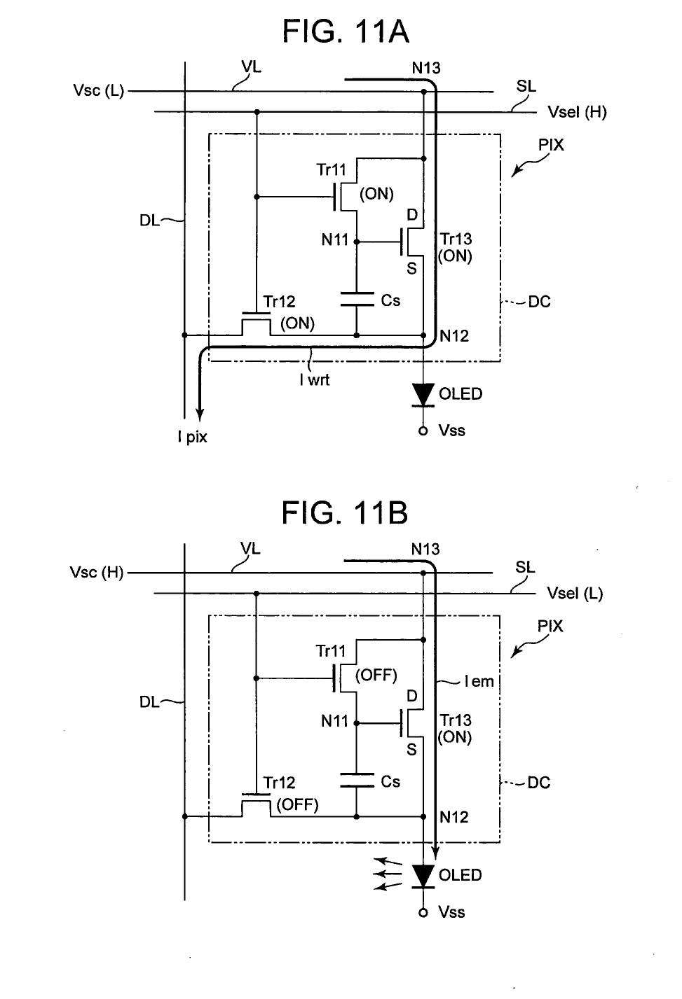

FIG. 10 is a timing chart illustrating the basic operation in the display pixels (the pixel driving circuit) according to the first embodiment. FIG. 11 is a schematic diagram illustrating the driving control operation in the display pixels (the pixel driving circuit) according to the present embodiment.

The driving control operation for the light emitting element (the organic electroluminescent element OLED) in the pixel driving circuit DC that has a circuit structure such as described above has, as shown in, for example, FIG. 10, one scan period Tsc as one cycle, wherein the one scan period Tsc is set so as to include a current writing operation period (selected period) Tse, and a light emitting operation period (non-selected period) Tnse). Note that the current writing operation period (selected period) Tse is an period wherein each of the color pixels PIX that are connected to the scan line SL are set to the selected state, and a gradation current Ipix that is in accordance with the display data that is supplied from the current control unit 140, described above, is written and maintained as a voltage component. Furthermore, the light emitting operating period (non-selected period) Tnse is an period wherein each of the color pixels PIX is set to the non-selected state, and a light emitting driving current in accordance with the display data, described above, is supplied to the organic electroluminescent element OLED, based on the voltage component that was written to and maintained during the current writing operation period Tse, to cause a light emitting operation at a specific brightness gradation. Here the current latching operation is performed simultaneously and in parallel during the period over which the current writing operation is performed in the current value converting circuit unit 141 of the current control unit 140, as described above.

### (Current Writing Operation Period)

Firstly, in the current writing operation (the current writing operation period Tse), as has been explained in the operation of the current control unit 140, described above (in reference to FIG. 6 and FIG. 7) and as shown in FIG. 10), a HIGH level (H) scan signal Vsel is applied to the scan line SL for a particular row (for example, row (2i−1) or row 2i) by the scan driver 120 to set the color pixel PIX for the applicable row into the selected state, while, additionally, a LOW level (L) power supply voltage Vsc is applied to the power supply line VL that is connected to the color pixel FIX for the applicable row. Additionally, synchronized with this timing, a gradation current Ipix, having a negative polarity and having a current value in accordance with the display data, is supplied to each data line DL from the current control unit 140 (the current latching/converting circuit 142a or 142b).

Doing so not only applies a LOW level power supply voltage Vsc to the contact N11 (one end of the capacitor Cs and the gate terminal of the transistor Tr13) by turning ON the transistors Tr11 and Tr12 that form the pixel driving circuit DC for the color pixels PIX, but also performs the operation of drawing (extracting) the gradation current Ipix in the direction of the current control unit 140 through the data line DL from the color pixel FIX (the pixel driving circuit DC). Doing this causes a voltage level that is even lower than the potential of the LOW level power supply voltage Vsc to be applied to the contact N12 (the other side of the capacitor Cs and the source terminal of the transistor Tr13).

The potential difference that is produced between the contacts N11 and N12 (across the gate and the source of the transistor Tr13 and across the ends of the capacitor Cs) turns the transistor Tr130N, so that, as shown in FIG. 11A, a writing current Iwrt, corresponding to the gradation current Ipix, flows towards the current control unit 140 through the transistor Tr13, the contact N12, the transistor Tr12, and the data line DL from the power supply line VL. Note that in order to cause this type of writing current Iwrt to flow, the low-voltage potential level Vee that is supplied to the current value converting circuit unit 141 (the current latching/converting circuits 142a and 142b) must be set to a voltage level that is even lower than the LOW level power supply voltage Vsc (for example, the ground potential).

At this time, an electric charge in accordance with the potential difference that is produced between the contacts N11 and N12 (across the gate and source of the transistor Tr13) is stored in the capacitor Cs, and is maintained (charged) as a voltage component. Additionally, a LOW level power supply voltage Vsc, having a voltage level that is lower than the constant voltage Vss (for example, the ground potential) that is applied to the cathode terminal of the organic electroluminescent element OLED, is applied to the power supply line VL, and the writing current Iwrt is controlled so as to flow to (or be drawn down from) the current control unit 140 through the data line DL, so the voltage that is applied to the anode terminal (the contact N12) of the organic electroluminescent element OLED will be lower than the potential of the cathode terminal (the constant voltage Vss) Because this results in the application of a reverse bias voltage to the organic electroluminescent element OLED, the light emission driving current does not flow to the organic electroluminescent element OLED, so there is no light emitting operation.

### (Light Emitting Operation Period)

Following this, in the light emitting operation (light emitting operation period Tnse) after the conclusion of the current writing operation, not only are the color pixels PIX of the applicable row set into a non-selected state through the application of the LOW level (L) scan signal Vsel to the scan line SL of each row by the scan driver 120, as shown in FIG. 10, but also the HIGH level (H) power supply voltage Vsc is applied to the power supply line VL of the applicable row. Additionally, synchronized with this timing, the supply of the gradation current Ipix by the current control unit 140 is interrupted to stop the draw-down operation.

Because of this, the transistors Tr11 and Tr12 are turned OFF, not only interrupting the application of the power supply voltage Vsc to the contact N11, but also interrupting the application of the voltage level accompanying the draw-down operation of the gradation power supply Ipix to the contact N12. Because of this, the capacitor Cs will maintain the stored charge in the current writing operation described above.

By the capacitor Cs maintaining the charge (the charged voltage) that is stored at the time of the current writing operation, the potential difference between the contacts N11 and N12 (between the gate and source of the transistor Tr13) will be maintained, maintaining in the conductive state (the ON state) so as to enable the transistor Tr13 to pass a current at a current value in accordance with the writing current Iwrt. Furthermore, the application, to the power supply line VL, of a power supply voltage Vsc that has a higher voltage level than the constant voltage Vss (for example, the ground potential), which is applied to the cathode terminal of the organic electroluminescent element OLED, causes the voltage that is applied to the anode terminal (contact N12) of the organic electroluminescent element OLED to be higher than the voltage of the terminal (the constant voltage Vss).

Furthermore, the application, to the power supply line VL, of a power supply voltage Vsc that has a higher voltage level than the constant voltage Vss (for example, the ground potential), which is applied to the cathode terminal of the organic electroluminescent element OLED, causes the voltage that is applied to the anode terminal (contact N12) of the organic electroluminescent element OLED to be higher than the voltage of the cathode terminal (the constant voltage Vss). Here the potential difference (charged voltage) based on the charge that is stored by the capacitor Cs corresponds to the potential difference when the transistor Tr13 passes a writing current Iwrt in accordance with the gradation current Ipix. Because of this, the light emitting driving current Iem that flows in the organic electroluminescent element OLED will have a current value that is equal to that of the writing current Iwrt, described above (which is essentially equal to the gradation current Ipix).

Because of this, during the light emitting operation period Tnse, the voltage component in accordance with the gradation current Ipix that was written during the current writing operation period Tse will be maintained, so the transistor Tr13 will be turned ON in a saturation state based thereon, so the light emitting driving current Iem will be supplied continuously. Because of this, the operation wherein the organic electroluminescent element OLED emits light at the brightness gradation in accordance with the current efficiency of each color pixel PIX and in accordance with the brightness gradation of the display data will be continuous.

Additionally, performing this type of series of driving control operations sequentially and repetitively for each row for all of the color pixels PIX that are arranged in the pixel array 110 writes one screen worth of display data with light emissions at specific brightness gradations, displaying the desired image information.

Here, in the pixel driving circuit DC according to the present embodiment, there are no particular limitations appertaining to the transistors Tr11 through Tr13; however, a structure using thin film transistors (field effect transistors) having identical channel polarity for all of the transistors Tr11 through Tr13 may be used. Consequently, an n-channel field effect transistor with an amorphous silicon semiconductor or a polysilicon semiconductor as the channel layer can be used in the same manner as for the current control unit 140 (the current value converting circuit unit 141 and the current latching/converting circuits 142a and 142b), discussed above.

Doing so enables the integrated fabrication of both the pixel array 110 wherein the color pixels PIX are arranged in a delta arrangement, provided with the pixel driving circuit DC according to the present embodiment, along with the current driving unit 140, on the same panel substrate (an insulating substrate) using the same manufacturing processes. In particular, in the case wherein the pixel array 110 and the current control unit 140 are structured using n-channel field effect transistors using amorphous silicon semiconductor layers, manufacturing technologies for amorphous silicon, which are already well established, can be used, making it possible to manufacture field effect transistors with stabilized operating characteristics relatively inexpensively, thus making it possible to achieve easily display devices with superior display quality.

Note that when the color pixel PIX (the pixel driving circuit DC) as described above is used, it is necessary to perform control so as to switch the voltage level of the power supply voltage Vsc that is applied to the power supply line VL that is provided in each row of the pixel array 110 during the current writing operation period Tse and the light emitting operation period Tnse, as shown in FIG. 10. In this case, it is possible to use a structure for the display device wherein, in addition to the structure illustrated in FIG. 1, a power supply driver is provided that applies a power supply voltage vcs, having a voltage level of the opposite polarity from the scan signal Vsel, synchronized with the timing of the output of the scan signal Vsel from the scan driver 120, described above, based on a power supply control signal supplied by, for example, the system controller 150, to the power supply line VL of each row of the pixel array 110. Here the power supply driver can use a structure that is provided with a shift register circuit and an output circuit (output buffer) that is the same as the scan driver 120, for example, described above.

Additionally, in the embodiment described above, the pixel array 110 had a structure wherein color pixels PIX of two different colors were connected alternatingly by rows to a single data line DL, and each power supply value converting circuit unit 141 of the current control unit 140 had a set of power supply converting circuits that provided a current mirror circuit for each data line DL. However, the present invention is not limited thereto, and instead there may be a power supply converting circuit for each color, corresponding to a plurality of colors, for each data line DL, where a plurality of color pixels PIX that is greater than 2 colors is connected to a single data line DL.

Additionally, while the scan driver 120 applied the scan signal Vsel sequentially to the individual scan lines SL of the pixel array 110, to set the color pixels PIX of each row sequentially into the selected state, the present invention is not limited thereto, but rather each row of color pixels PIX may be put into the selected state in any given order.

Additionally, in the color pixels PIX according to the embodiment described above, a circuit structure was illustrated corresponding to a current specifying method of a type wherein the gradation current Ipix was extracted through the data line DL from the color pixel PIX (the pixel driving circuit DC) through the provision of three transistors as the pixel driving circuit DC and generating a gradation current Ipix, with a negative polarity, by the current control unit 140. However, the present invention is not limited thereto, but may have a different circuit structure insofar as there is a pixel driving circuit that uses, at least, a current specifying method. Furthermore, there may be a circuit structure corresponding to the state wherein the gradation current Ipix is generated with a positive polarity using the current control unit 140, and the gradation current Ipix is pushed into the color pixels PIX (the pixel driving circuit DC) through the data line DL.

Furthermore, in the embodiment described above, a structure was illustrated using an organic electroluminescent element OLED as the light emitting element for structuring the color elements PIX. However, the display device according to the present invention is not limited thereto, but rather, for example, other current-controlled light emitting elements, such as light emitting diodes, may be used suitably.

### Second Embodiment

A second embodiment of a display device according to the present invention will be described next in reference to the figures.

In the first embodiment, described above, it was explained that a set (a pair) of current latching/converting circuits equipped with current mirror circuits each having different current ratios is connected in parallel to the data line of an individual column, and operations are repeated alternatingly for each row wherein as the data current output from the current driver is received and maintained in one current latching/converting circuit, simultaneously a gradation current is applied to the color pixel in accordance with the data current that was received and maintained during the previous operating period by the other current latching/converting circuit.

In the second embodiment, there is a distinctive feature wherein, in a set of current receiving/converting circuits that is connected to the data line in parallel, an operation wherein a gradation current in accordance with the data current is supplied to the color pixel at the same time as the data current is received by one of the current receiving/converting circuits is repetitively performed alternating with another current receiving/converting circuit.

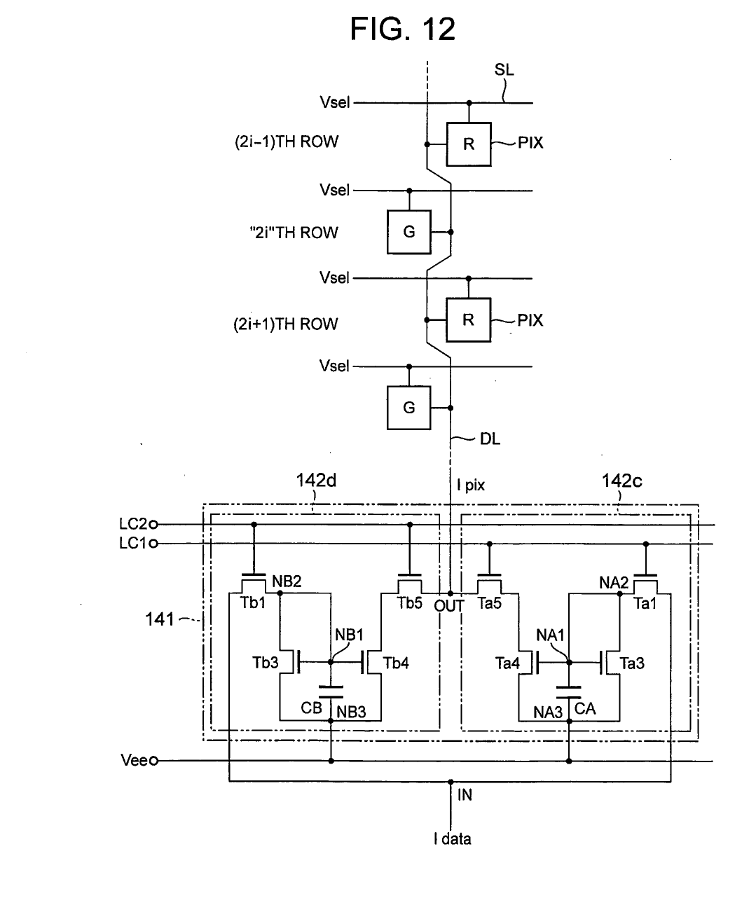

FIG. 12 is a circuit structural diagram illustrating the second embodiment of a current control unit (current value converting circuit unit) that can be applied to the display device according to the present invention.

Here explanations are omitted or abbreviated for the structures that are identical to those in the first embodiment, described above (the display device illustrated in FIG. 1, the critical structures in the display device illustrated in FIG. 2, and the current driver illustrated in FIG. 3).

The current control unit 140, as illustrated in FIG. 2 and FIG. 12, has current value converting circuit units 141 (141-1, 141-2, . . . , 141-m) connected in parallel to a set of current receiving/converting circuits 142c and 142d for the data line DL of each column. Here the current receiving/converting circuit 142c according to the present embodiment has a circuit structure wherein the transistor Ta2 between the contacts NA1 and NA2 is eliminated from the current latching/converting circuit 142a illustrated in the first embodiment (shown in FIG. 4), described above, and a switching control signal LC1 is applied to the control terminals (gate terminals) of the transistors Ta1 and Ta5. Furthermore the current receiving/converting circuit 142d has a circuit structure wherein the transistor Tb2 between the contacts NB1 and NB2 is eliminated from the current latching/converting circuit 142b illustrated in the first embodiment (shown in FIG. 4), described above, and a switching control signal LC2 is applied to the control terminals (gate terminals) of the transistors Tb1 and Tb5.

Additionally, the current mirror circuits (transistors Ta3 and Ta4 and transistors Tb3 and Tb4) that are provided in each of the current receiving/converting circuits 142c and 142d are set so that the ratio of the gradation currents Ipix that flows through the transistor Ta4 or Tb4 relative to the data current Idata that flows on the transistor Ta3 or transistor Tb3 side (the current ratios) are in accordance with the current efficiency of the color pixels PIX to which the current writing operation is performed, as was the case in the first embodiment (and, for example, Table 1 and Table 2) described above.

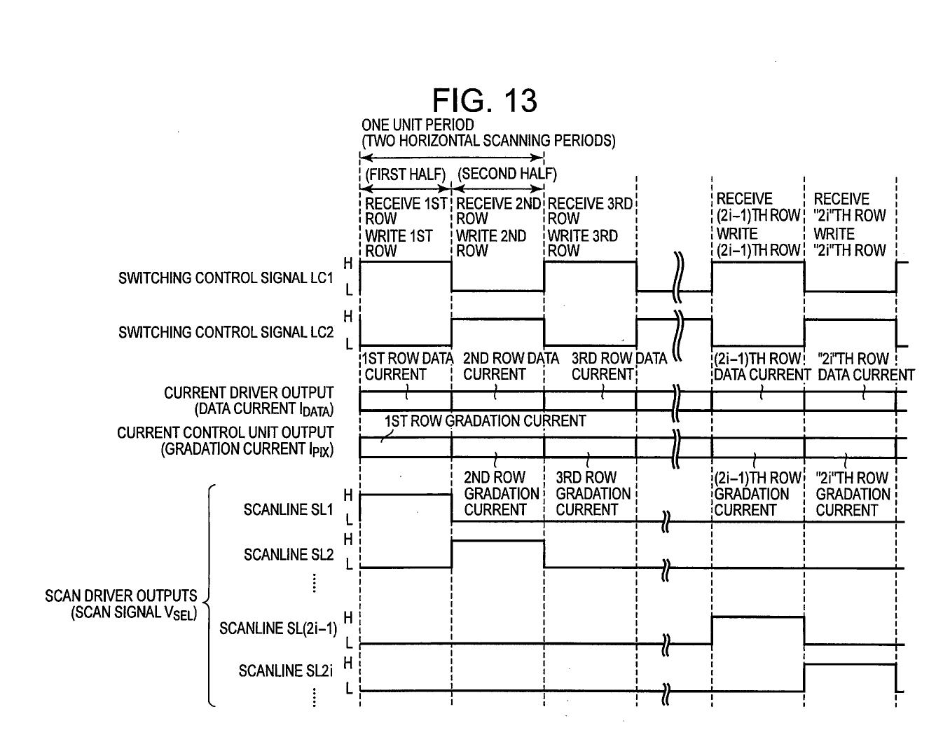

FIG. 13 is a timing chart illustrating an example of a driving control operation (a driving method) in the display device according to the present embodiment. Here, a specific description will be given regarding the writing operation for display data for color pixels FIX of the odd number (2i−1) rows and of the even number (2i) rows (where “i” is a positive integer fulfilling 1=2i−1=n−1, and 2=2i=n), for the case wherein the pixel array 110 is a pixel array of n rows by m columns (where n is an odd number and m is a multiple of 3), as with the first embodiment.

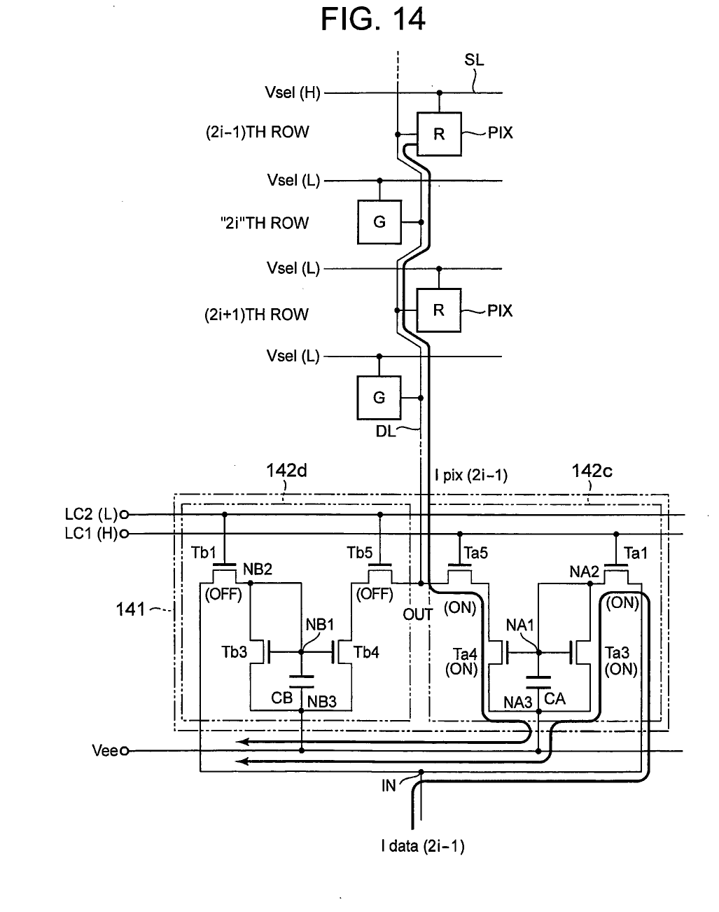

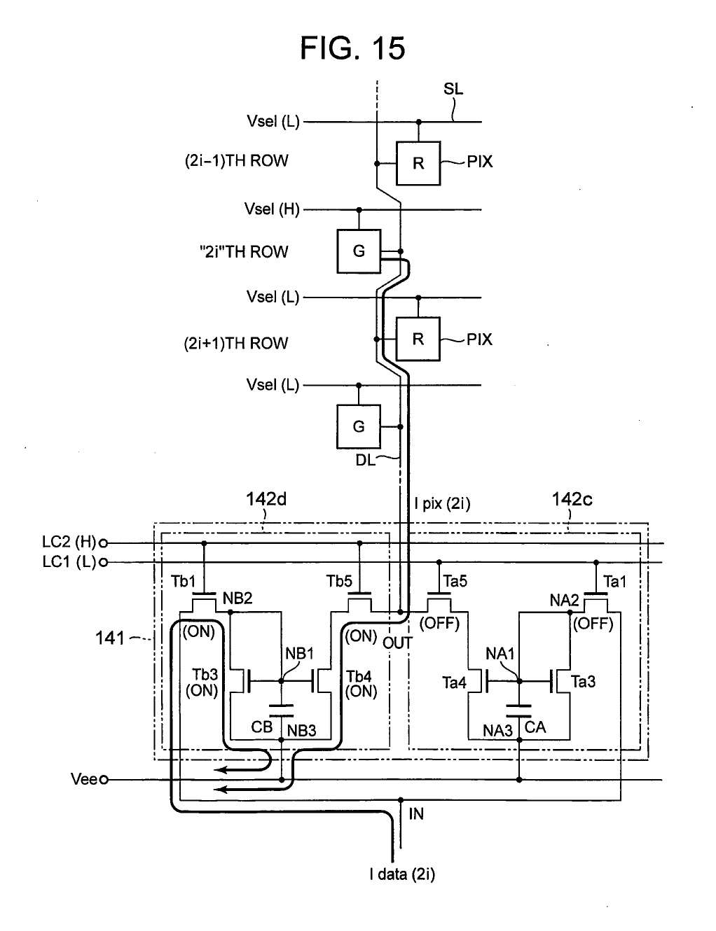

Moreover, FIG. 14 through FIG. 15 are operation schematic diagrams illustrating the operating states in a current control unit (current value converting circuit unit) according to the present embodiment.

The driving control operation in the display device according to the present embodiment uses one horizontal scan period as a unit period, and the current writing operation is performed simultaneously with the current receiving operation during the one horizontal scan period. The current receiving operation is the operation wherein the data current Idata that is in accordance with the brightness gradation value of the display data for one row, supplied from the current driver 130, is received by one of the pair of current receiving/converting circuits 142c and 142d of the current value converting circuit unit 141 that is provided for each column of the current control unit 140. Moreover, the current writing operation is the operation that generates the gradation currents Ipix that have specific current ratios, shown in Table 1 or Table 2, described above, relative to the data currents Idata that are received, and writes these gradation currents Ipix to each of the color pixels PIX in the specific row.

That is, first, during a first operating period, as shown in FIG. 13 and FIG. 14, in the current value converting circuit unit 141, the switching control signal LC1 that is supplied as a current control signal from the system controller 150 is set to the HIGH level (H) and the switching control signal LC2 is set to the LOW level (L). Because of this, the transistors Ta1 and Ta5 in the current receiving/converting circuit 142c are turned ON and the transistors Tb1 and Tb5 in the current receiving/converting circuit 142d are turned OFF.

Additionally, the data current Idata (2i−1) that corresponds to the display data for the color pixels PIX in each column for a specific row (for example, row (2i−1)) is supplied from the current driver 130, synchronized with this timing, turning the transistor Ta3 ON in the saturation domain. The data current Idata (2i−1) flows in the direction of the low-voltage potential Vee through transistors Ta1 and Ta3, and contact NA3, and the current level of the data current Idata (2i−1) is converted into a voltage level (a voltage component) across the gate and source of the transistor Ta3, producing a specific potential at contact NA1 (current receiving operation).

At this time, the transistor Ta4, which forms the current mirror together with the transistor Ta3, is turned ON by the voltage that appears at the contact NA1. Because of this, the gradation current Ipix (2i−1), which has a current value in accordance with the current efficiency of the color pixel PIX in the applicable row, based on the voltage at the contact NA1, flows so as to be drawn in the direction of the low-voltage potential Vee from the data line DL side through the transistors Ta5 and Ta4.

Additionally, synchronized with this timing, a scan signal Vsel of the select level (HIGH level) will be applied to the scan line SL of the row to which the display data is being written by the scan driver 120 (for example, row (2i−1), to set into the selected state the other pixels PIX of the applicable row. Doing so causes the gradation current Ipix (2i−1), described above, to flow so as to be extracted in the direction of the current control unit 140 through each data line DL so that a charge (voltage component) that is in accordance with the gradation current Ipix (2i−1) will be maintained in the pixel driving circuit DC of the individual color pixels PIX (the red (R) color pixel in FIG. 14) (current writing operation).

Note that during this first operating period, the transistors Tb1 and Tb5 of the current receiving/transforming circuit 142d are set to the OFF state. Because of this there is no current flowing on the 142d side, so neither the data current receiving operation nor the gradation current writing operation is performed on the 142d side.

Next, during a second operating period, as shown in FIG. 13 and FIG. 15, the switching control signal LC1 that is supplied as a current control signal from the system controller 150 is set to the LOW level (L) and the switching control signal LC2 is set to the HIGH level (H). Because of this, the transistors Ta1 and Ta5 in the current receiving/converting circuit 142c are turned OFF and the transistors Tb1 and Tb5 in the current receiving/converting circuit 142d are turned ON.

Additionally, the data current Idata (2i) that corresponds to the display data for the color pixels PIX in each column for the next row (such as row (2i)) is supplied from the current driver 130, synchronized with this timing, turning the transistor Tb3 ON in the saturation domain. The data current Idata (2i) flows in the direction of the low-voltage potential Vee through transistors Tb1 and Tb3, and contact NB3, and the current level of the data current Idata (2i) is converted into a voltage level (a voltage component) across the gate and source of the transistor Tb3, producing a specific potential at contact NB1 (current receiving operation).

At this time, the transistor Tb4, which forms the current mirror together with the transistor Tb3, is turned ON by the voltage that appears at the contact NB1. Because of this, the gradation current Ipix (2i), which has a current value in accordance with the current efficiency of the color pixel PIX in the applicable row, based on the voltage at the contact NB1, flows so as to be drawn in the direction of the low-voltage potential Vee from the data line DL side through the transistors Tb5 and Tb4.

Additionally, the color pixels PIX of the row to which the display data (such as row 2i) is to be written are set to the selected state, synchronized with this timing. Doing so causes the gradation current Ipix (2i), described above, to flow so as to be extracted in the direction of the current control unit 140 through each data line DL so that a charge (voltage component) that is in accordance with the gradation current Ipix (2i) will be maintained in the pixel driving circuit DC of the individual color pixels PIX (the green (G) color pixel in FIG. 15) (current writing operation).

Note that during this second operating period, the transistors Ta1 and Ta5 of the current receiving/transforming circuit 142c are set to the OFF state. Because of this there is no current flowing on the 142c side, so neither the data current receiving operation nor the gradation current writing operation is performed on the 142c side.

In this way, control in the present embodiment is such that an operation wherein a current receiving operation and a current writing operation are performed simultaneously by only one of the current receiving/converting circuits, of the set of current receiving/converting circuits 142c and 142d that is provided in the current value converting circuit unit 141, is repeated alternatingly by the set of current receiving/converting circuits 142c and 142d.

Given the present embodiment, as the data currents that are generated for each color pixel based on the brightness gradation values that are included in the display data are received they are simultaneously converted into current values in accordance with the current efficiencies of the individual color pixels to output the gradation currents through the data lines DL of the individual columns. Because of this, there is no need, as there was in the first embodiment, described above, to perform the data current receiving operation (current latching operation) for the specific color pixels in a separate operating period from the gradation current outputting operation (gradation writing operation), nor is there that need to maintain (latch) the voltage component in accordance with the received data current. Because of this, it is possible to start the display operations for the desired image data immediately, using a simple circuit structure and driving method.

### Third Embodiment

A third embodiment of a display device according to the present invention will be described next in reference to the figures.

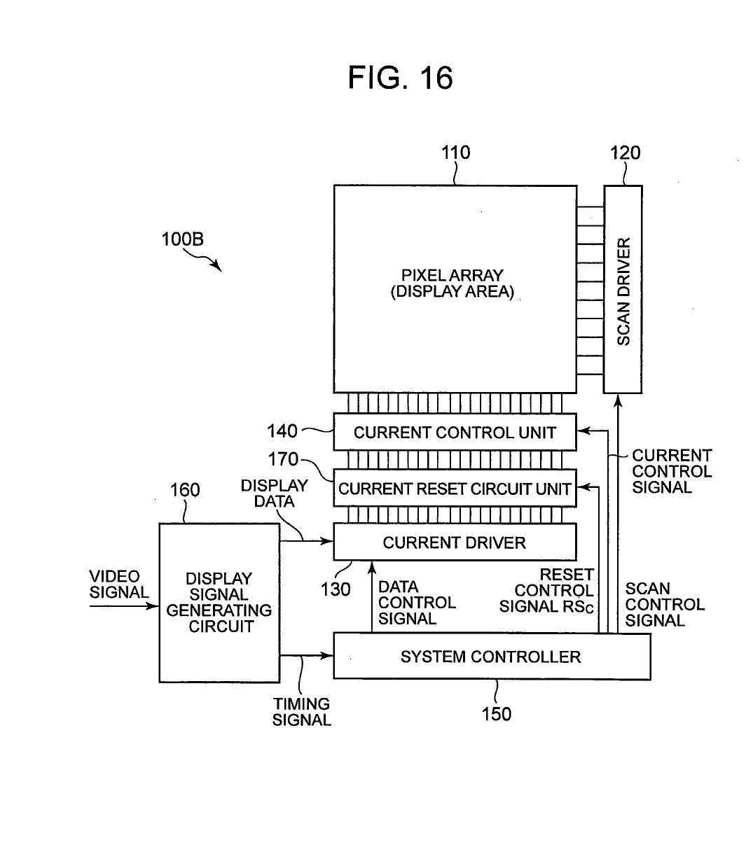

FIG. 16 is a schematic block diagram illustrating a third embodiment of a display device according to the present invention.

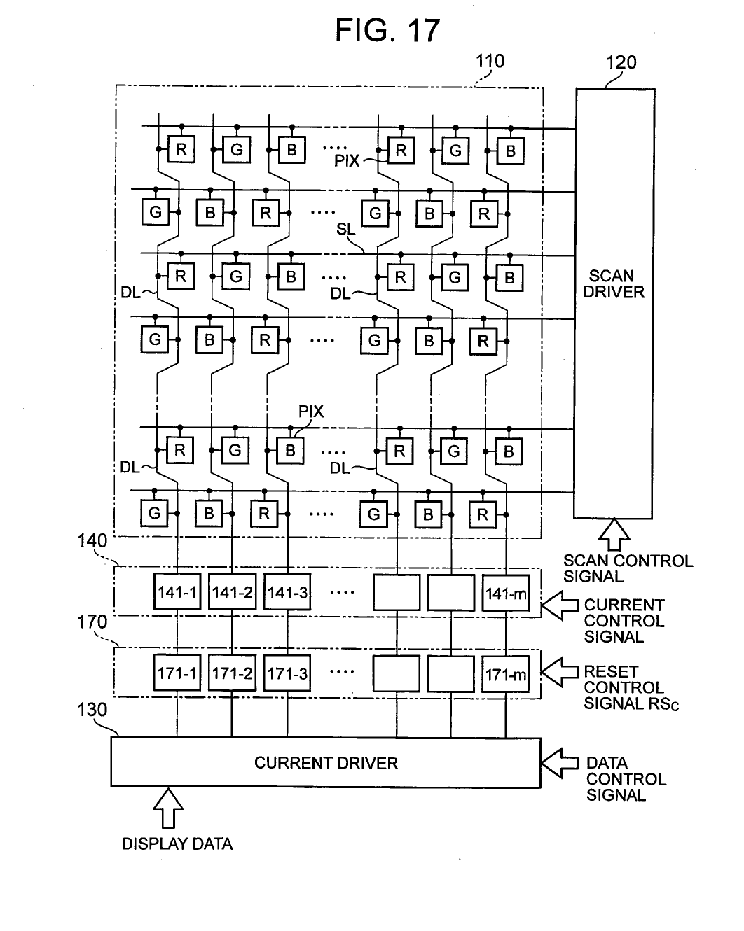

FIG. 17 is a schematic structural diagram illustrating the critical structures (the pixel array, the current control unit, and a current reset circuit unit) in a display device according to the present embodiment.

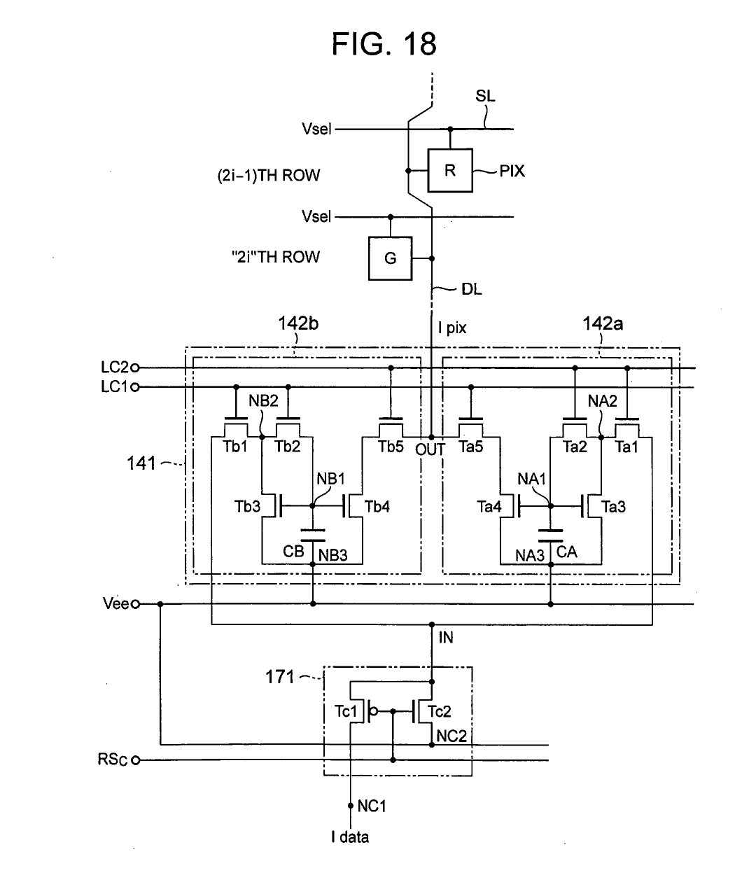

FIG. 18 is a circuit structural diagram illustrating an example of a current control unit (current value converting circuit unit) and current reset circuit unit (reset circuit) that can be applied to the display device according to the present embodiment.

Here the structures that are similar to those in the first embodiment, described above, are assigned similar or identical codes, and explanations thereof are abbreviated or omitted.

The display device 100B according to the present embodiment, as illustrated in FIG. 16, comprises, in addition to the pixel array 110, the scan driver 120, the current driver 130, the current control unit 140, the system controller 150, and the display signal generating circuit 160, which are similar to those of the display device 100A illustrated in the first embodiment (illustrated in FIG. 1 and FIG. 2), a current reset circuit unit 170, for applying a specific reset voltage to the current value converting circuit units 141 (the current latching/converting circuits 142a and 142b) for the individual columns of the current control unit 140, between the current driver 130 and the current control unit 140.

The current reset circuit unit 170, as shown in FIG. 17 for example, is provided with, for example, reset circuits 171-1, 171-2, 171-3, . . . , 171-m, for each data line DL of each column. Each reset circuit 171 (171-1, 171-2, 171-3, . . . , 171-m) as shown in FIG. 18, for example, has a circuit structure provided with a transistor Tc1 and a transistor Tc2. The current path (source-drain) of the transistor Tc1 is connected between the input contact NC1, which inputs the data current Idata from the current driver 130, described above, and the input contact IN of the current value converting circuit unit 141. The current path of the transistor Tc2 is connected between a contact NC2, to which the specific low-voltage potential Vee is applied, and the input contact IN.

Here a p-channel thin film transistor is used as the transistor Tc1 and an n-channel thin film transistor is used as the transistor Tc2. Additionally, a reset control signal RSc, which is supplied as a current control signal from the system controller 150, is applied in common to the control terminals (gates) of the transistor Tc1 and Tc2. Note that field effect transistors having, for example, a polysilicon semiconductor as the channel layer, may be used for the transistors Tc1 and Tc2. Consequently, the current reset circuit unit 170 according to the present embodiment may be fabricated integrally with the current driver 130.

In the current reset circuit unit 170 (the reset circuits 171) according to the present embodiment, one of the transistors Tc1 or Tc2 is turned ON, and the other is turned OFF, based on a reset control signal RSc that is supplied as a reset control signal from the system controller 150. As a result, a current passing operation and the reset operation are performed selectively. Here the “current passing operation” is the operation that passes, to the current control unit 140 for each the data current Idata based on the brightness gradation value for one row of display data, supplied from the current driver. Moreover, the reset operation is an operation (reset operation) for resetting (initializing), by applying a specific reset voltage (the low-voltage potential Vee), to the current control unit 140 for each individual row, to discharge the residual charge to the current value converting circuit unit 141 (the current latching/converting circuits 142a and 142b).

Next the driving method in a display device wherein the aforementioned reset circuit unit is provided will be explained in reference to the figures.

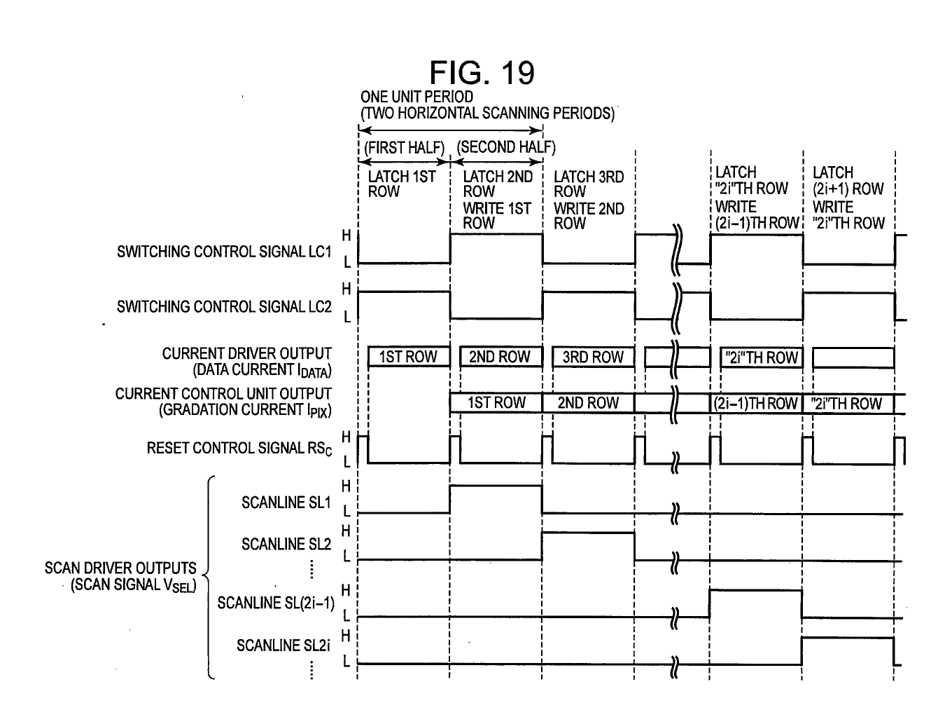

FIG. 19 is a timing chart illustrating an example of a driving control operation (the driving method) in the display device according to the present embodiment.

Here a driving control operation (reset operation) that is unique to this embodiment will be explained in detail; see the first embodiment (FIG. 5), described above, regarding the other operations (the current latching operation and the current writing operation). Explanations thereof are abbreviated or omitted.

In the driving control operation in the display device 100B according to the present embodiment, control is such that the reset operation will be performed with timing that is in advance of the current latching operation, as described above, in each of the one horizontal scan periods in the driving control operation according to the first embodiment, illustrated in FIG. 5. Here, the reset operation is an operation for resetting, by applying a specific low-voltage potential Vee to discharge the residual charge, for the current latching/converting circuits 142a and 142b) that receive and maintain the applicable data current Idata. Additionally, the reset operation is controlled so as to be repetitively performed alternating between the pair of current latching/converting circuits 142a and 142b, which form the current value converting circuit unit 141, with each individual one horizontal scan period.

Specifically, first, during a first operating period (the first-half one horizontal scan period, where two horizontal scan periods is defined as a unit period), as shown in FIG. 19, the switching control signal LC1 that is supplied as a current control signal from the system controller 150 is set to the LOW level (L) and the switching control signal LC2 is set to the HIGH level (H). As a result, transistors Ta1 and Ta2 are turned ON and transistor Ta5 is turned OFF in the current latching/converting circuit 142a, and transistors Tb1 and Tb2 are turned OFF and transistor Tb5 is turned ON in the current latching/converting circuit 142b.

As a result, the reset circuit 171 and the current mirror circuit (transistors Ta3 and Ta4, and contact NA1) of the current latching/converting circuit 142a are connected electrically through the transistors Ta1 and Ta2, and the data line DL and the current latching/converting circuit 142a are disconnected from each other electrically by the transistor Ta5. Additionally, when in this state, the reset circuit 171 and the current mirror circuit (transistors Tb3 and Tb4, and contact NB1) of the current latching/converting circuit 142b are disconnected electrically by the transistors Tb1 and Tb2, and the data line DL and the current latching/converting circuit 142b are connected electrically through the transistor Ta5.

Simultaneously with this timing, the reset control signal RSc that is supplied from the system controller 150 is set to the HIGH level (H), turning OFF transistor Tc1 and turning ON transistor Tc2 of the reset circuits 171 that are provided for each current reset circuit unit 170. As a result, the specific low-voltage potential Vee is applied to the contact NA1 through the transistor Tc2 of the reset circuit 171, the input terminal IN of the current value converting circuit unit 141, and transistors Ta1 and Ta2 of the current latching/converting circuit 142a, to discharge the stored charge remaining in the capacitor CA (the reset operation).

Following this, the reset control signal RSc that is supplied from the system controller 150 is set to the LOW level (L), turning ON transistor Tc1 and turning. OFF transistor Tc2 of the reset circuits 171. Simultaneously with this timing, the data current Idata (2i−1) that corresponds to the brightness gradation values of the display data for the color pixels PIX in each column for a specific row (for example, row (2i−1)) is supplied from the current driver 130, synchronized with this timing, and is applied the input terminal IN of the current value converting circuit unit 141 through the transistor Tc1 of the reset circuit 171. Consequently, there is electrical shorting between the gate and the drain of transistor Ta of the current latching/converting circuit 142a, which turns ON in the saturation region, so the data current Idata (2i−1) flows in the direction of the low-voltage potential Vee through transistors Ta1 and Ta3 and contact NA3. Because of this, the current level of the data current Idata (2i−1) will be converted into a voltage level (the voltage component) across the gate and source of the transistor Ta3, and is stored as an electrical charge in the capacitor CA (the current latching operation).

Next, during a second operating period (the second-half one horizontal scan period when two horizontal scan periods is defined as a unit period), the switching control signal LC1 is set to the HIGH level (H) and the switching control signal LC2 is set to the LOW level (L) As a result, transistors Ta1 and Ta2 are turned OFF and transistor Ta5 is turned ON in the current latching/converting circuit 142a, and transistors Tb1 and Tb2 are turned ON and transistor Tb5 is turned OFF in the current latching/converting circuit 142b.

At this time, in the current latching/converting circuit 142a, a voltage (high-voltage) is maintained in the contact NA1 based on the charge that is stored in the capacitor CA by the current latching operation, described above. Because of this, the transistor Ta4 is turned ON, inducing a gradation current Ipix (2i−1), having a current value based on the charge stored in the capacitor CA (that is, based on the data current Idata), towards the low-voltage potential vee through the transistors Ta5 and Ta4 from the data line side.

Additionally, synchronized with this timing, a scan signal Vsel of the select level (HIGH level) will be applied to the scan line SL of the row to which the display data is being written by the scan driver 120 (for example, row (2i−1)), to set into the selected state the other pixels PIX of the applicable row. Consequently, a charge (voltage component), depending on the gradation current Ipix (2i−1), is maintained in the pixel driving circuit DC that is provided for each pixel PIX.

On the other hand, in the current latching/converting circuit 142b, the reset circuit 171 and the current mirror circuit (transistors Tb3 and Tb4, and contact NB1) are connected electrically through the transistors Tb1 and Tb2, and the data line DL is disconnected electrically by the transistor Tb5.

Simultaneously with this timing, the reset control signal RSc that is supplied from the system controller 150 is set to the HIGH level (H). As a result, the transistor Tc1 is turned OFF and the transistor Tc2 is turned ON in the reset circuit 171, and the specific low-voltage potential Vee is applied to the contact NB1 through transistors TB1 and TB2 of the current latching/converting circuit 142b, to discharge the stored charge remaining in the capacitor CA (the reset operation).

Following this, the reset control signal RSc that is supplied from the system controller 150 is set to the LOW level (L), turning ON transistor Tc1 and turning OFF transistor Tc2 of the reset circuit 171. Simultaneously with this timing, the data current Idata (2i) that corresponds to the brightness gradation values of the display data for the color pixels PIX in each column for the next row (for example, row 2i) is supplied from the current driver 130 and is applied to the input terminal IN of the current value converting circuit unit 141 through the transistor Tc1 of the reset circuit 171. Consequently, there is electrical shorting between the gate and the drain of transistor Tb3 of the current latching/converting circuit 142b, which turns ON in the saturation region, so the data current Idata (2i) flows in the direction of the low-voltage potential Vee through transistors Tb1 and Tb3 and contact NB3. Because of this, the current level of the data current Idata (2i) will be converted into a voltage level (the voltage component) across the gate and source of the transistor Tb3, and is stored as an electrical charge in the capacitor CB (the current latching operation).

Following this, by repeatedly performing this type of series of driving control operations, not only is it possible to discharge the charge that remains in the current value converting circuit unit 141 (the current latching/converting circuits 142a and 142b) that receives the data current Idata in accordance with the display data to perform initialization in advance, but also to continuously receive the data current Idata for each row from the current driver 130 while writing the gradation current Ipix in accordance with the current efficiency of the applicable color pixel PIX, for the color pixels PIX of each row.

Consequently, in the present embodiment the charge that is remaining in the current mirror circuit of the current latching/converting circuit can be discharged through the current latching operation and the current writing operation in the current value converting circuit unit (the current latching/converting circuit) for each column. Because of this, it is possible to prevent a phenomenon wherein the color pixel (light emitting element) cannot perform the light emitting operation at a brightness gradation that is in accordance with the display data because the gradation current changes from the actual current value that is in accordance with the display data due to charge that is remaining in the current mirror circuit of the current latching/converting circuit. Consequently, it is possible to achieve a display device having a desirable display quality by preventing the occurrence of, for example, non-uniform display, brightness deviations, and the like.

Note that in the present embodiment, the explanation is for a structure, as shown in FIG. 18, wherein a reset circuit unit (reset circuit) having the characteristics of the present embodiment is applied to the current converting circuit unit (current latching/converting circuit unit) shown in the first example embodiment, described above (shown in FIG. 4). However, the reset circuit unit may, of course, also be used in the second embodiment, described above (shown in FIG. 12).

In this case, as the method for driving the display device, control is performed, in the timing chart illustrated in FIG. 13, wherein, prior to the operation for writing the gradation current to each pixel for the applicable row simultaneously with receiving the display data (data current) for the color pixels for each row in each one horizontal scan period, the reset operation described above is performed for the current latching/converting circuits that perform the receiving/writing operations. Another display device according to the third embodiment, described above, will be described next.

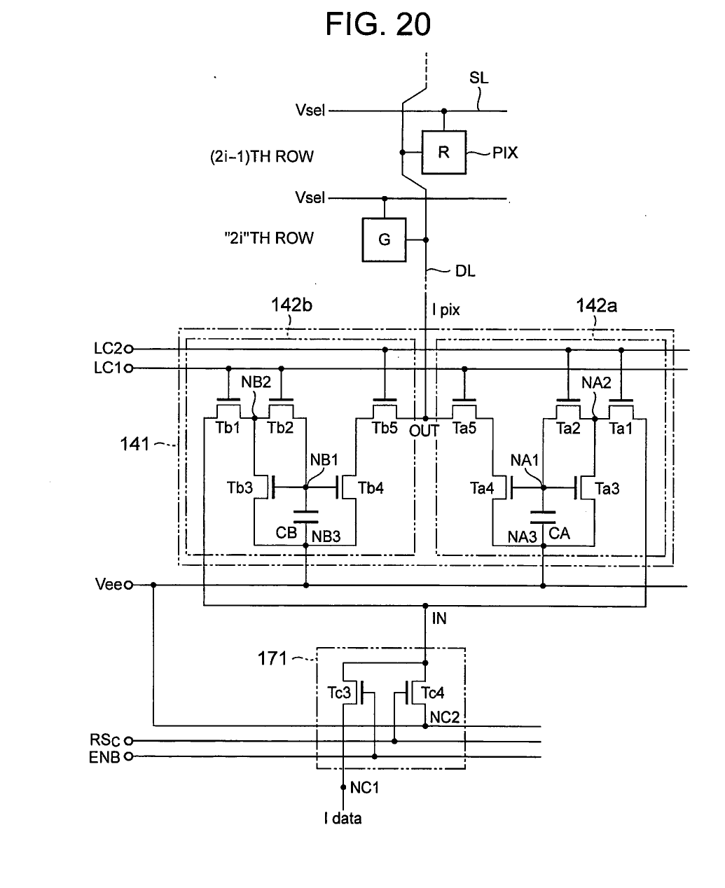

FIG. 20 is a circuit structural diagram illustrating another example of a current control unit (current value converting circuit unit) and reset circuit unit (reset circuit) that can be applied to the display device according to the present embodiment.

Here explanations are omitted or abbreviated for structures that are identical to those of FIG. 18.

In the current reset circuit unit 170 (the reset circuit 171) illustrated in FIG. 18, a circuit structure is illustrated wherein a p-channel thin film transistor is used as the transistor Tc1 and an n-channel thin film transistor is used as the transistor Tc2. However, in the present embodiment there is a circuit structure wherein only thin film transistors of a single channel type are used.

The reset circuit 171 according to the present embodiment, as shown in FIG. 20, for example, has a circuit structure provided with a transistor Tc3 and a transistor Tc4. The current path (source-drain) of the transistor Tc3 is connected between the input contact NC1, which inputs the data current Idata from the current driver 130, described above, and the input contact IN of the current value converting circuit unit 141, and the enable signal ENB that is supplied from the system controller 150 is applied to the control terminal (gate) thereof. The current path of the transistor Tc4 is connected between a contact NC2, to which the specific low-voltage potential vee is applied, and the input contact IN and the reset control signal RSc, supplied from the system controller 150, are applied to the control trouble thereof.

Here the enable signal ENB that is applied to the transistor Tc3, and the reset control signal RSc that is applied to the transistor Tc4 have a mutually inverted phase relationship. Additionally, the transistors Tc3 and Tc4 use n-channel thin film transistors in both, so control is such that when one of the transistors Tc3 or Tc4 is in the ON state, the other is in the OFF state.

Note that field effect transistors having, for example, an amorphous silicon semiconductor as the channel layer, may be used for the transistors Tc3 and Tc4. Doing so enables the integrated fabrication of the current reset circuit 170 on the same panel substrate (an insulating substrate) as the current control unit 140 and the pixel array 110 (pixel driving circuit DC) and using the same manufacturing processes.

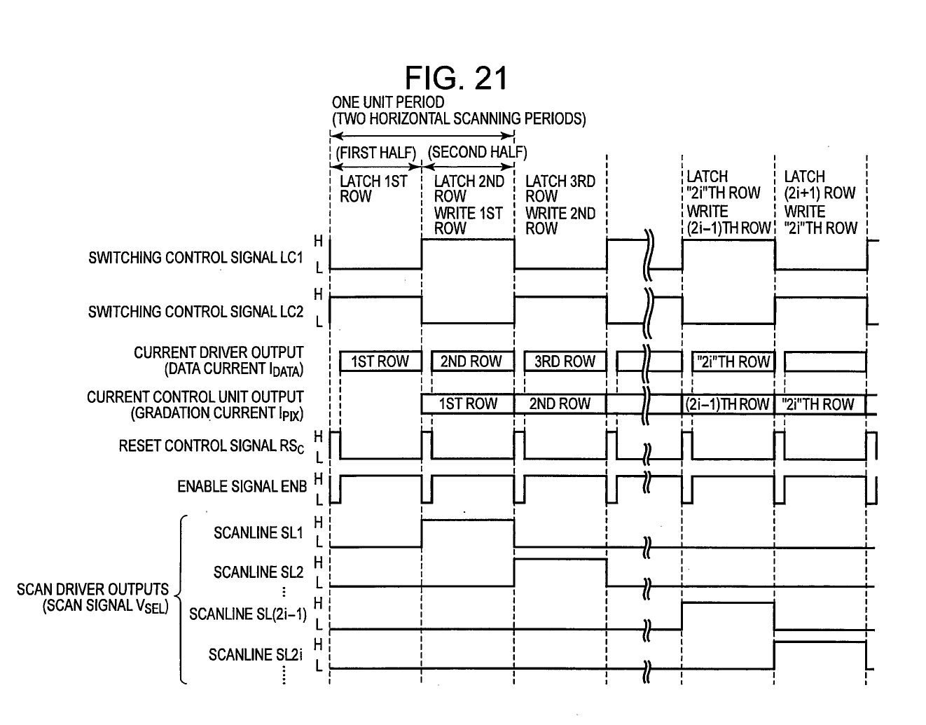

FIG. 21 is a timing chart illustrating an example of a driving control operation in the display device according to the present embodiment.

Here a driving control operation (reset operation) that is unique to the present embodiment will be explained in detail, and explanations of the other operations (the current latching operation and the current writing operation) will be abbreviated or omitted, referencing FIG. 19.

In the present embodiment, as with the driving control operation illustrated in FIG. 19, control is such that the current latching operation is performed after performing an operation (the reset operation) for resetting the current latching/converting circuit 142a or 142b within each one horizontal scan period. Additionally, simultaneously and in parallel with the execution of the applicable reset operation and the current latching operation, a current writing operation is performed to the color pixels in a specific row.

That is, as shown in FIG. 21, during a specific operating period, the switching control signal LC1 is set to the LOW level (L) and the switching control signal LC2 is set to the HIGH level (H). As a result, transistors Ta1 and Ta2 are turned ON and transistor Ta5 is turned OFF in the current latching/converting circuit 142a, and transistors Tb1 and Tb2 are turned OFF and transistor Tb5 is turned ON in the current latching/converting circuit 142b. In this state, the reset control signal RSc that is supplied from the system controller 150 is set to the HIGH level (H) and the enable signal ENB is set to the LOW level (L), turning OFF transistor Tc3 and turning ON transistor Tc4 of the reset circuit 171. As a result, the specific low-voltage potential Vee is applied to the contact NA1 through the transistor Tc4 of the reset circuit 171, the input terminal IN of the current value converting circuit unit 141, and transistors Ta1 and Ta2 of the current latching/converting circuit 142a, to discharge the stored charge remaining in the capacitor CA (the reset operation).

Next, the reset control signal RSc that is supplied from the system controller 150 is set to the LOW level (L) and the enable signal ENB is set to the HIGH level (H), turning ON transistor Tc3 and turning OFF transistor Tc4 of the reset circuit 171. Simultaneously with this timing, the data current Idata (2i) that corresponds to the brightness gradation values of the display data for the color pixels PIX in each column for a specific row (for example, row 2i) is supplied from the current driver 130, and is applied to the input terminal IN of the current value converting circuit unit 141 through the transistor Tc3 of the reset circuit 171. As a result, the data current Idata (2i) flows in the direction of the low-voltage potential Vee through transistors Ta1 and Ta3 of the current latching/converting circuit 142a and through contact NA3, and the current level of the data current Idata (2i) is converted into a voltage level (a voltage component) across the gate and source of the transistor Ta3, and is stored as electric charge in the capacitor CA (current latching operation).

In the present embodiment, the charge that is remaining in the applicable current value converting circuit unit (current latching/converting circuit) can be discharged to perform initialization prior to the current latching operation in the current value converting circuit unit for each column. Because of this, it is possible to generate, and to supply to each color pixel, a gradation current that has a current value that is appropriate to the display data and to the current efficiency, and possible to achieve a desirable display quality through controlling the occurrence of, for example, non-uniform displays and brightness deviations, and the like.

Note that the voltage component corresponding to the data current Idata (2i) that is received and stored in the current latching/converting circuit 142a by the current latch operation is, in the same manner as in the first and third embodiments, described above, converted into gradation currents Ipix (2i) that have current values that are in accordance with the current efficiencies of the individual color elements PIX in the second row, and are supplied through the data lines DL for the individual columns during the next operating period.

Moreover, during the operating period wherein the aforementioned reset operation and current writing operation are performed, based on the charge (voltage component) that is stored in the capacitor CB by the current latching operation in the previous operating period in the current latching/converting circuit 142b, that is, the current latching operation that receives and latches the data current Idata (2i−1) corresponding to the display data for the color pixels PIX of row (2i−1), the transistor Tb4 turns ON to cause a gradation current Ipix (2i−1) to be drawn towards the low-voltage potential Vee through the transistors Tb5 and Tb4 from the data lines DL. As a result, by the scan driver 120 setting into the selected state the color pixels PIX of row (2i−1), synchronized with this timing, charges (voltage components) are maintained in accordance with the aforementioned gradation currents Ipix (2i−1) on the pixel driver circuits DC wherein the individual color pixels PIX are provided.

### Fourth Embodiment

A forth embodiment of a display device according to the present invention will be described next in reference to the figures.

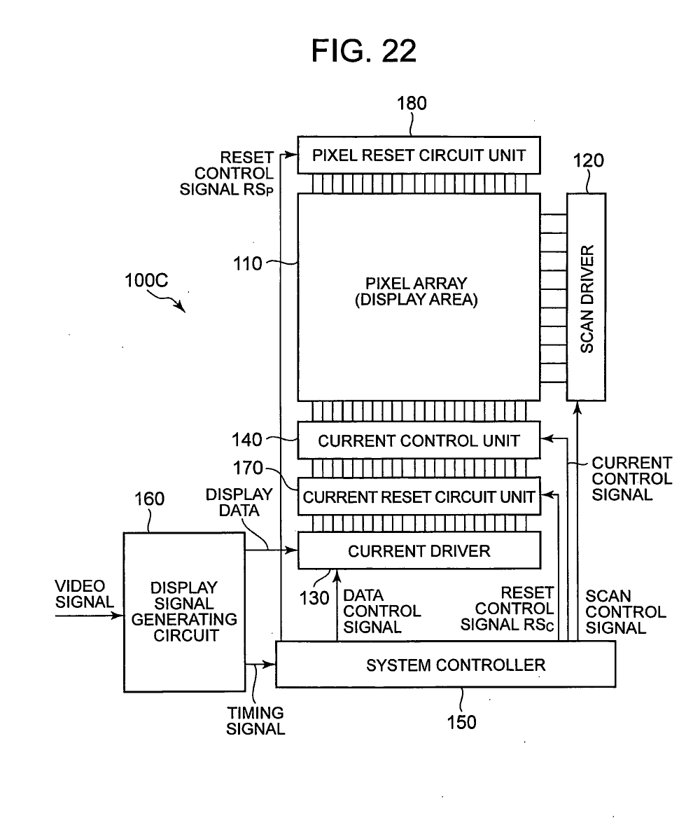

FIG. 22 is a schematic block diagram illustrating a fourth embodiment of a display device according to the present invention.

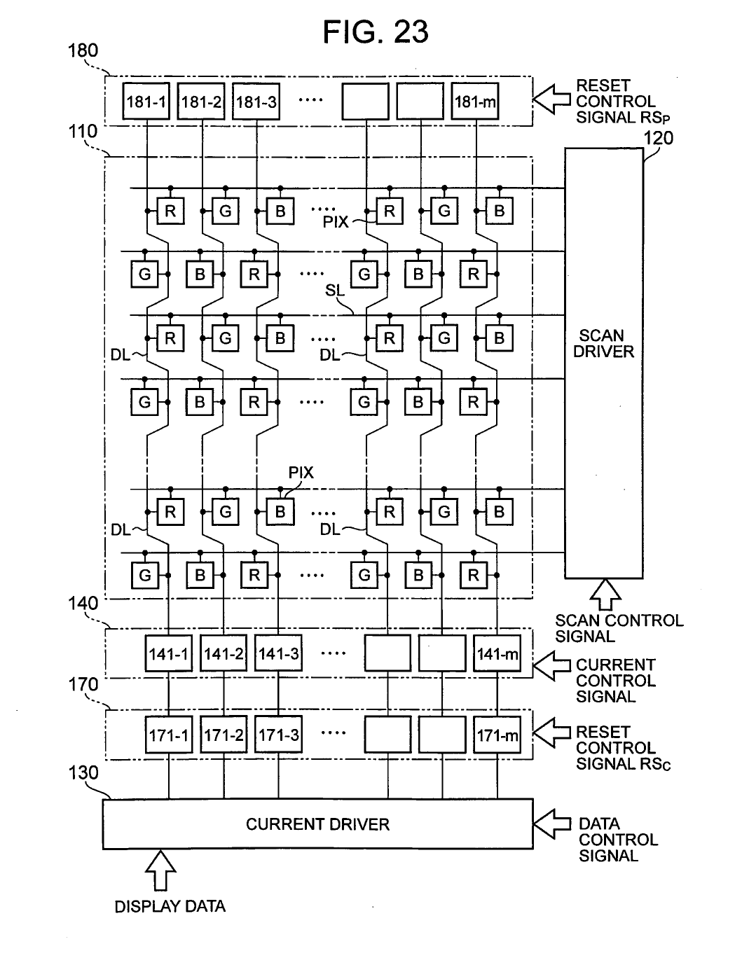

FIG. 23 is a schematic structural diagram illustrating the critical structures (the pixel array, the current control unit, a reset circuit unit, and a pixel reset circuit unit) in a display device according to the present embodiment.

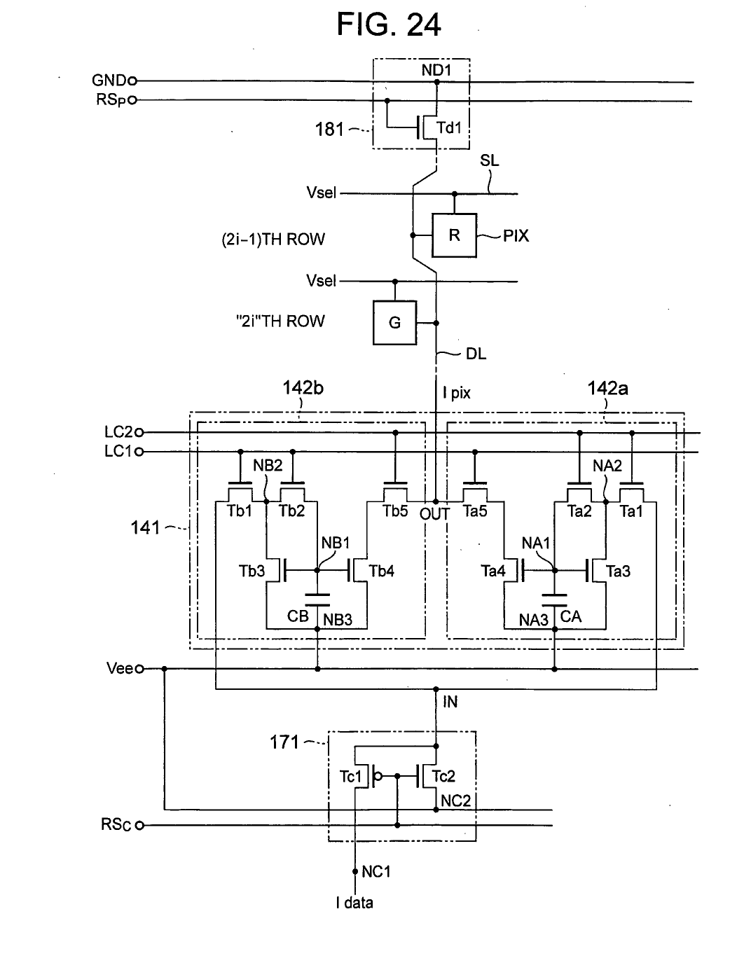

FIG. 24 is a circuit structural diagram illustrating an example of a current control unit (current value converting circuit unit), a reset circuit unit (reset circuit), and a pixel reset circuit unit (reset circuit) that can be applied to the display device according to the present embodiment.

Here the structures that are similar to those in the first embodiment or third embodiment, described above, are assigned similar or identical codes, and explanations thereof are abbreviated or omitted.

The display device 100C according to the present embodiment, as illustrated in FIG. 22 and FIG. 23, comprises, in addition to the pixel array 110, the scan driver 120, the current driver 130, the current control unit 140, the system controller 150, the display signal generating circuit 160, and the current reset circuit unit 170, which are similar to those of the display device 100B illustrated in the third embodiment (illustrated in FIG. 16 and FIG. 17), a pixel reset circuit unit 180, for applying a specific reset voltage to the data lines disposed in the column direction of the pixel array 110, described above, and to the individual color pixels PIx that are arranged in the delta arrangement.

The pixel reset circuit unit 180, as shown in FIG. 23 for example, is provided with, for example, reset circuits 181-1, 181-2, 181-3, . . . , 181-m, for each data line DL of each column. Each reset circuit 181 (181-1, 181-2, 181-3, . . . , 181-m) as shown in FIG. 24, for example, is connected between the contact ND1, to which the ground potential GND is applied, and a data line DL, and has a circuit structure provided with a transistor Td1 wherein a reset control signal RSp, supplied as a reset control signal from the system controller 150, is applied to the control terminal thereof.

Here a thin film transistor (field effect transistor) that uses, for example, an n-channel amorphous silicon semiconductor can be used for the transistor Td1. Doing so enables the integrated fabrication of the pixel reset circuit 180 according to the present embodiment on the same panel substrate (an insulating substrate) as the pixel array 110 (pixel driving circuit DC) and the current control unit 140 using the same manufacturing processes.

In the pixel reset circuit unit 180 (reset circuit 181) according to the present embodiment, the transistor Td1 turns ON based on the reset control signal RSp that is applied as a reset control signal from the system controller 150 to apply a specific reset voltage (the ground potential GND) to the data line DL of each of the columns provided in the pixel array 110. As a result, the charge that is remaining in the color pixels PIX in the data line and the rows that are set to the selected state will be discharged, performing a reset (initialization) operation (pixel reset operation).

Next the driving method in a display device wherein the aforementioned reset circuit unit is provided will be explained in reference to the figures.

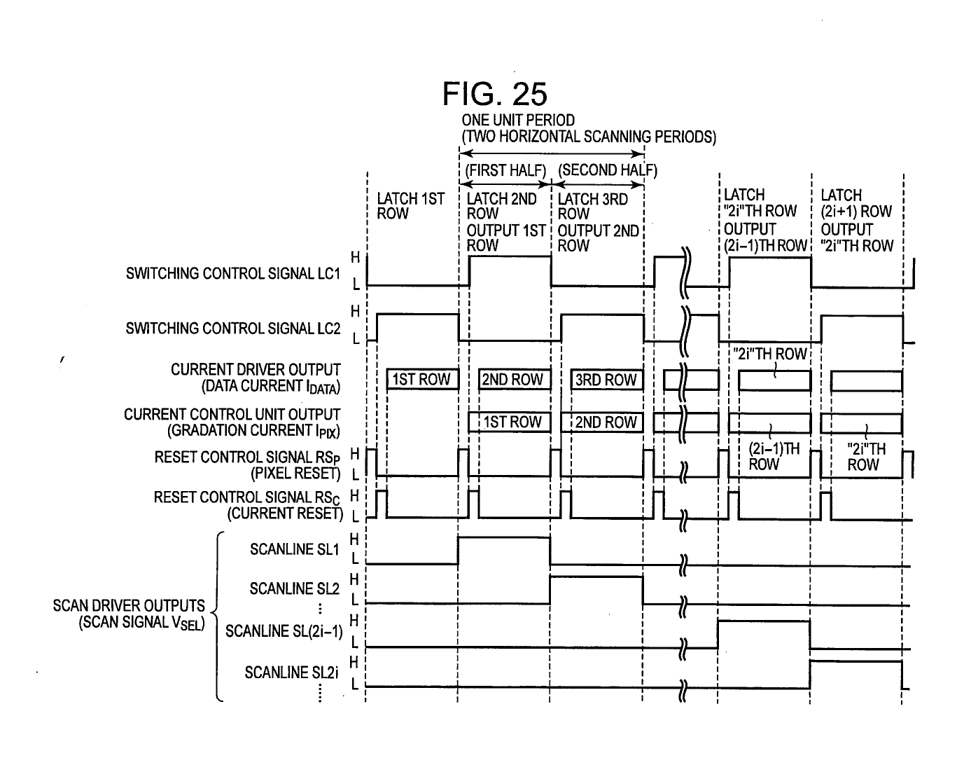

FIG. 25 is a timing chart illustrating an example of a driving control operation (the driving method) in the display device according to the present embodiment.

Here a driving control operation (pixel reset operation, reset operation) that is unique to this embodiment will be explained in detail; see the first embodiment or third embodiment (FIG. 5, FIG. 19), described above, regarding the other operations (the current latching operation and the current writing operation) Explanations thereof are abbreviated or omitted.

In the driving control operation in the display device 100C according to the present embodiment, control is such that the pixel reset operation is performed within each one horizontal scan period. The pixel reset operation is an operation that resets the individual color pixels PIX of the row that is the subject of the writing operation for the display data (gradation current Ipix), through the data line DL for each column, by discharging the residual charge through applying the ground voltage GND all at once, with a timing that is prior to the reset operation in the driving control operation according to the third embodiment illustrated in FIG. 19.

Specifically, first, during a first operating period (the first-half one horizontal scan period, where two horizontal scan periods is defined as a unit period), as shown in FIG. 25, the switching control signals LC1 and LC2, supplied as current control signals from the system controller 150 to the current control unit 140, are set to the LOW level (L). As a result, transistors Ta1, Ta2, and Ta5 in the current latching/converting circuit 142a, and transistors Tb1, Tb2, and Tb5 in the current latching/converting circuit 142b are turned OFF. As a result, the data lines DL are electrically disconnected from the current value converting circuit units 141 (the current latching/converting circuits 142a and 142b).

Simultaneously with this timing, the reset control signal RSp that is supplied from the system controller 150 to the pixel reset circuit unit 180 is set to the HIGH level (H), and the scan signal Vsel of the selected level (the HIGH level) is applied to the scan lines of, for example, row (2i−1) from the scan driver 120.

As a result, the transistor Td1 of the reset circuit 181 that is provided for each row in the pixel reset circuit unit 180 is turned ON, and the color pixels PIX of row (2i−1) are set into the selected state. As a result, the ground voltage GND is applied to each of the color pixels PIX of the row (2i−1) through the transistors Td1 in the data lines DL, discharging the residual charge that is stored in the capacitors Cs (shown in FIG. 9) provided in the pixel driving circuits DC for the applicable color pixels PIX and that is stored in the data lines DL.

Following this, the reset control signal RSp that is supplied from the system controller 150 to the pixel reset circuit unit 180 is set to the LOW level (L), turning ON transistor Td1 of the reset circuits 181 to disconnect the application of the ground voltage GND to the data lines DL. Simultaneously with this timing, the reset control signal RSc that is supplied from the system controller 150 to the current reset circuit unit 170 is set to the HIGH level (H), turning OFF the transistor Tc1 and turning ON the transistor Tc2 of the reset circuit unit 171 to apply the specific low-voltage potential Vee to the current control unit 140.

Simultaneously with this timing, the switching control signal LC1 that is supplied from the system controller 150 to the current control unit 140 is set to the HIGH level (H), turning ON the transistors Tb1 and Tb2 and turning OFF the transistor Tb5 of the current latching/converting circuit 142b. As a result, the low-voltage potential Vee that is applied through the reset circuit unit 171 (the transistor Tc2) is applied to the contact NB1 through the transistors Tb1 and Tb2 of the current latching/converting circuit 142b to discharge the stored charge remaining in the capacitor CB (the reset operation).

Following this, the reset control signal RSc that is supplied from the system controller 150 to the current reset circuit unit 170 is set to the LOW level (L), turning ON transistors Tc1 and turning OFF transistors Tc2 of the reset circuits 171. The data current Idata (2i) that corresponds to the brightness gradation values of the display data for the color pixels PIX in each column for row 2i is supplied from the current driver 130, synchronized with this timing, and is applied to the current value converting circuit unit 141 through the transistor Tc1 of the reset circuit 171. As a result, the transistor Tc3 of the current latching/converting circuit 142b turns ON in the saturation region, so the data current Idata (2i) flows in the direction of the low-voltage potential vee through transistors Tb1 and Tb3 and contact NB3. Because of this, the current level of the data current Idata (2i) will be converted into a voltage level (the voltage component) across the gate and source of the transistor Tb3, which is stored as an electrical charge in the capacitor CB (the current latching operation).

Note that after the pixel reset operation for the color pixels PIX in row (2i−1), described above, the operation for writing, to the applicable color pixels PIX, the gradation currents Ipix (2i−1) that correspond to the data currents Idata (2i−1), corresponding to the color pixels PIX for the row (2i−1), which were received and maintained, in the previous operating period, in the current latching/converting circuit 142a, as shown in FIG. 25, is performed simultaneously and in parallel during the operating period wherein the reset operation and the current latching operation of the current latching/converting circuit 142b, which receives and maintains the data current Idata (2i), corresponding to the color pixels PIX of row 2i, is performed. This operation is identical to the writing operation (the current writing operation) for the gradation currents Ipix (2i) in accordance with the data currents Idata (2i) to the color-pixels PIX of row 2i, which will be explained below, so the exclamation thereof is omitted.

Following this, in the second operating period (the second half one horizontal scan period, where two horizontal scan periods is defined as a unit period), the switching control signals LC1 and LC2 are set to the LOW level (L) to electrically disconnect the data lines DL from the current value converting circuit units 141 (the current latching/converting circuits 142a and 142b), in the same manner as with the pixel reset operation for the color pixels PIX in row (2i−1), described above. In the state, the reset control signal RSp that is supplied to the pixel reset circuit unit 180 is set to the HIGH level (H), turning ON the transistor Td1, and the color pixels PIX of row 2i are set to the selected state by the scan driver 120. As a result, the ground voltage GND is applied to each of the color pixels PIX of the applicable row through the each of the data lines DL, discharging the residual charge that is stored in the pixel driving circuits DC (the capacitors Cs) and in the data lines DL.

Next, the reset control signal RSp that is supplied to the pixel reset circuit unit 180 is set to the LOW level (L), cutting off the application of the ground voltage GND to the data lines DL, and the reset control signal RSc that is supplied by the current reset control unit 170 is set to the HIGH level (H), applying the specific low-voltage potential Vee to the current-control unit 140. Moreover, synchronized with this timing, a reset operation for discharging the residual charge that is stored in the capacitor CA of the current latching/converting circuit 142a, as with the case described above, is performed by setting the switching control signal LC2 to the HIGH level (H) and the current latching operation for receiving and maintaining the data currents Idata (2i+1) corresponding to the color pixels PIX in row (2i+1) is performed. Simultaneously, the current writing operation for writing to the applicable color pixels PIX the gradation currents Ipix (2i), in accordance with the data currents. Idata (2i) corresponding to the color pixels PIX of row 2i, received and maintained in the current latching/converting circuit 142b during the first operating period is performed at this time.

That is to say, the transistors Tb1 and Tb2 are turned ON and the transistor Tb5 is turned OFF in the current latching/converting circuit 142b through the switching control signal LC1 being set to the LOW level (L) and the switching control signal LC2 being set to the HIGH level (H). Because of this, a gradation current Ipix (2i), having a current value based on the charge stored in the capacitor CB (that is, based on the data current Idata) is drawn towards the low-voltage potential Vee through the transistors Tb5 and Tb4 from the data line side. As a result, in the pixel reset operation described above, charges (voltage components) in accordance with the gradation currents Ipix (2i) are maintained in the pixel driving circuits DC for the applicable color pixels PIX by maintaining the selected state that was set to the color pixels PIX in row 2i (current writing operation).

Following this, by repeatedly performing this type of series of driving control operations, not only is it possible to discharge the charge that remains in the current value converting circuit unit 141 (the current latching/converting circuits 142a and 142b) that receives the data currents Idata in accordance with the display data, in the color pixels PIX to which the gradation currents Ipix have been written, and in the data lines DL, to thereby perform initialization in advance, but also to continuously write the gradation currents Ipix in accordance with the current efficiencies of the applicable color pixels PIX to the color pixels PIX in each row while receiving continuously the data currents Idata for each row from the current driver 130.

Consequently, in the present embodiment the charge that is remaining in each color pixel and data line, and in the current mirror circuits of the current latching/converting circuits, can be discharged through the current latching operation and the current writing operation in the current value converting-circuit unit (the current latching/converting circuits) for each column. Because of this, it is possible to prevent a phenomenon wherein the color pixel (light emitting element) cannot perform the light emitting operation at a brightness gradation that is in accordance with the display data because the gradation current changes from the actual current value that is in accordance with the display data due to charge that is remaining in the individual color pixels and data lines, and in the current mirror circuits of the current latching/converting circuits. Consequently, it is possible to achieve a display device having a desirable display quality by preventing the occurrence of, for example, non-uniform display, brightness deviations, and the like.

Note that in the present embodiment, the explanation is for a structure, as shown in FIG. 24, wherein both a pixel reset circuit unit (reset circuit) having the characteristics of the present embodiment, and the reset circuit unit (reset circuit) having the characteristics of the third embodiment are applied to the display device shown in the first example, described above (shown in FIG. 2). However, the present invention is not limited thereto, but rather the pixel reset circuit unit may instead be used alone.

Note that in the present embodiment, the explanation is for a structure wherein a pixel reset circuit unit (reset circuit) having the characteristics of the present embodiment is applied to the display device shown in the first example embodiment, described above (shown in FIG. 2). However, the reset circuit unit may, of course, also be used in the display device shown in the second embodiment, described above (shown in FIG. 12).

In this case, as the method for driving the display device, control is performed, in the timing chart illustrated in FIG. 13, wherein, prior to the operation for writing the gradation current to each pixel for the applicable row simultaneously with receiving the display data (data current) for the color pixels for each row in each one horizontal scan period, the reset operation described above is performed for the color pixels in the line for which the receiving/writing operations are performed.

Another display device according to the fourth embodiment, described above, will be described next.

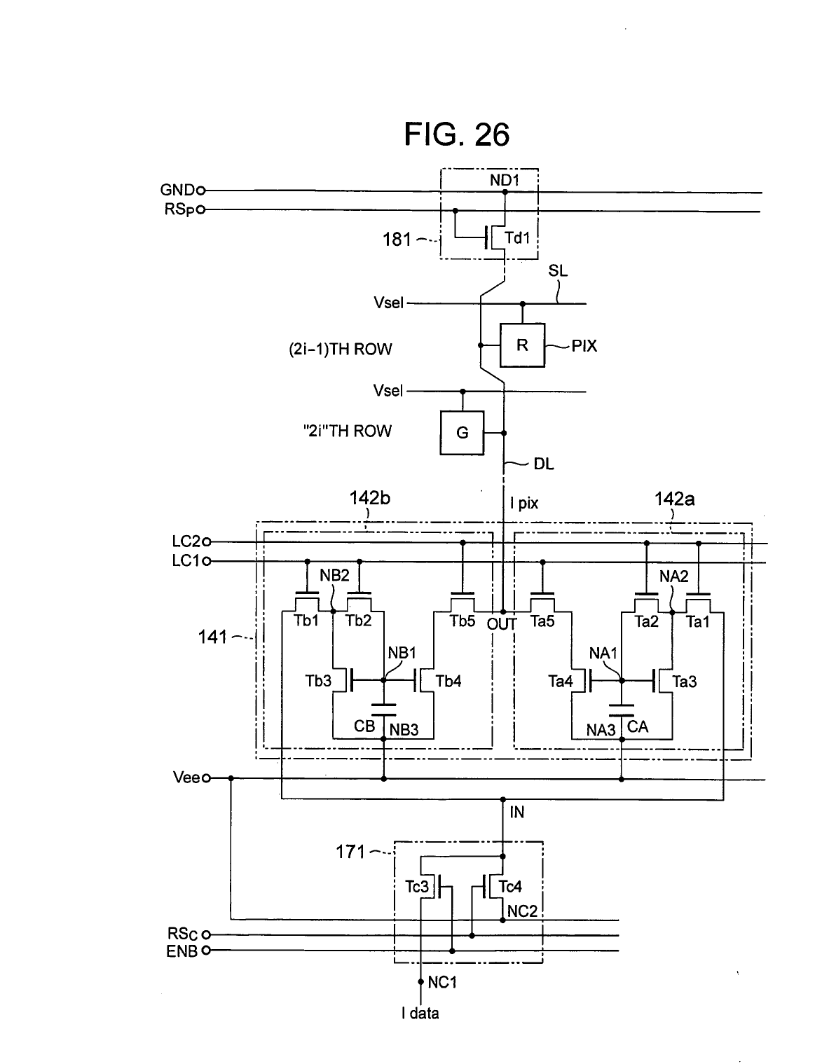

FIG. 26 is a circuit structural diagram illustrating another example of a current control unit (current value converting circuit unit), a reset circuit unit (reset circuit), and a pixel reset circuit unit (reset circuit) that can be applied to the display device according to the present embodiment.

Here explanations are omitted or abbreviated for structures that are identical to those of the third embodiment (shown in FIG. 20), or of FIG. 24, described above.

In the present embodiment, as with the third embodiment (shown in FIG. 20), described above, the transistors Tc3 and Tc4 that are used in the current reset circuit unit 170 (reset circuits 171) are structured from thin film transistors having the same channel types (for example, n-type channels).

That is, as shown in FIG. 26, the reset circuit 171 comprises a transistor Tc3 that passes the data current Idata, inputted from the current driver 130, to the current value converting circuit unit 141 based on an enable signal ENB, and a transistor Tc4 that applies the specific low-voltage potential Vee to the current value converting circuit unit 141 based on the reset control signal RSc. Additionally, the enable signal ENB and the reset control signal RSc, described above, are set so as to have a mutually inverted phase relationship.

Here a thin film transistor (field effect transistor) that uses, for example, an n-channel amorphous silicon semiconductor can, as described above, be used for the transistor Td1 that is used in the pixel reset circuit unit 180 (the reset circuits 181). Because of this, the present embodiment enables the integrated fabrication of the current reset circuit 170 in addition to the pixel reset circuit 180 on the same panel substrate (an insulating substrate) as the pixel array 110 (pixel driving circuit DC) and the current control unit 140, using the same manufacturing processes.

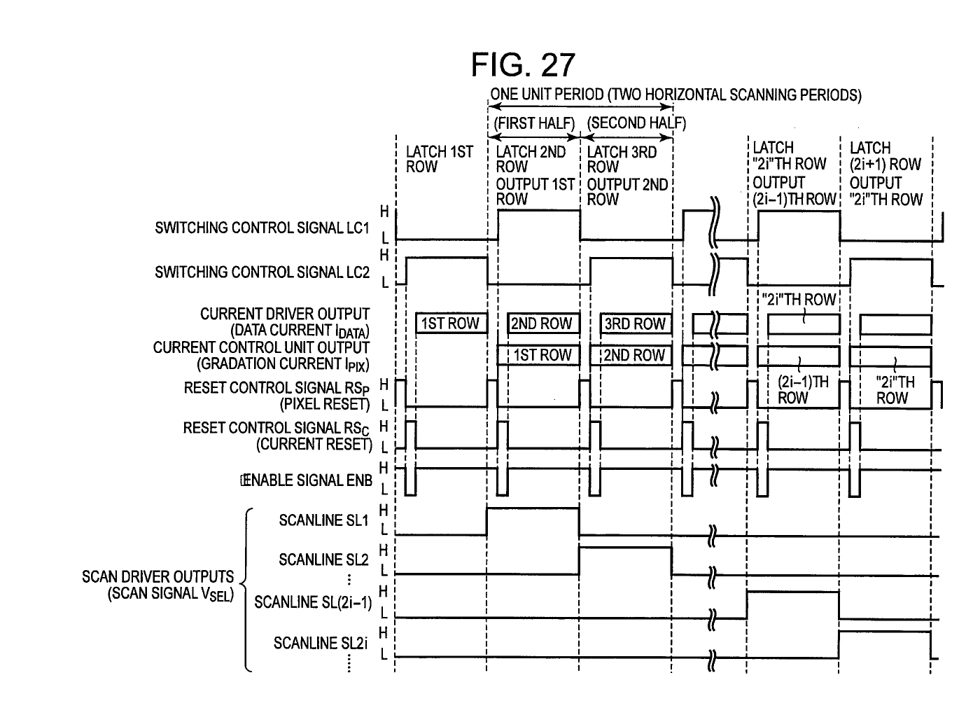

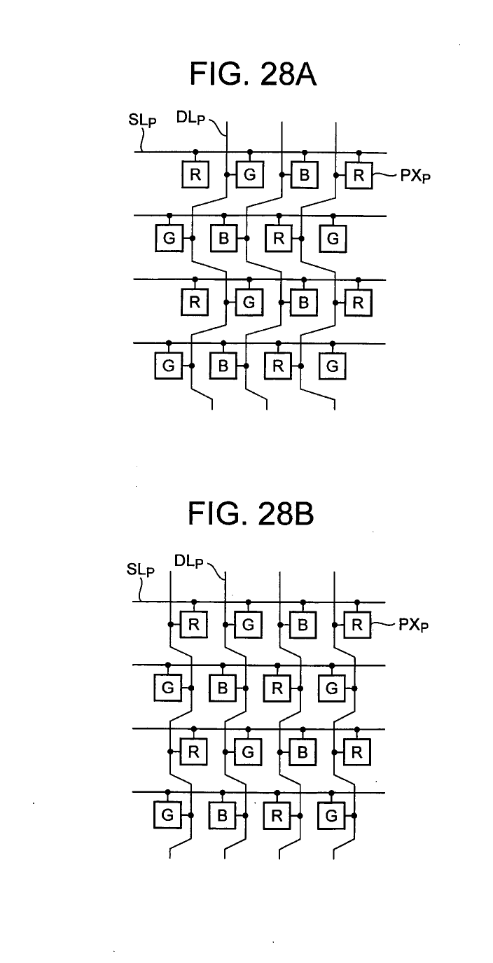

FIG. 27 is a timing chart illustrating an example of a driving control operation in the display device according to the present embodiment.

Here a driving control operation (pixel reset operation and reset operation) that is unique to the present embodiment will be explained in detail, and explanations of the other operations (the current latching operation and the current writing operation) will be abbreviated or omitted.

In the present embodiment, as with the driving control operation illustrated in FIG. 25, control is such that as the pixel reset operation and the current reset operation (the mirror circuit reset operation) are performed sequentially within each one horizontal scan period, the current writing operation and current latching operation, described above, are also performed simultaneously and in parallel. Here the pixel reset operation is an operation that discharges the residual charge that is stored in the pixel driving circuits DC of the color pixels PIX in the applicable row (2i−1), and control is performed so that the pixel reset operation is performed prior to the current writing operation for writing the gradation current Ipix (2i−1) to the color pixels FIX of the row (2i−1). Moreover, the current reset operation (mirror circuit reset operation) is an operation that resets the current latching/converting circuits 142a or 142b to which the applicable data currents Idata (2i) are written, where control is performed so as to perform the current reset operation (mirror circuit reset operation) prior to the current latching operation that receives and maintains, in the current value converting circuit unit 141 (the current latching/converting circuits 142a or 142b), the data current Idata (2i) corresponding to the display data for the color pixels PIX of row (2i).

That is, as shown in FIG. 27, first during a specific operating period, the switching control signals LC1 and LC2 are set to the LOW level (L), so the transistors Ta1, Ta2, and Ta5 in the current latching/converting circuit 142a, and transistors Tb1, Tb2, and Tb5 in the current latching/converting circuit 142b are turned OFF. In this state, the reset control signal RSp that is supplied to the pixel reset circuit unit 180 is set to the HIGH level (H), and the scan signal Vsel of the selected level (the HIGH level) is applied to the scan lines of, for example, row (2i−1) from the scan driver 120. As a result, the ground voltage GND is applied to each of the color pixels FIX of the row (2i−1) through the data lines DL, discharging the residual charge that is stored in the applicable color pixels Index, the pixel driving circuits DC, and the data lines DL.

Next, the reset control signal RSp that is supplied to the pixel reset circuit unit 180 is set to the LOW level (L), the reset control signal RSc that is supplied to the current reset circuit unit 170 is set to the HIGH level (H), the enable signal ENB is set to the LOW level (L), and the switching control signal LC1 is set to the HIGH level (H). Doing so causes the specific low-voltage potential Vee to be applied to the current latching/converting circuit 142b, discharging the residual charge that is stored in the capacitor CB (reset operation).

Thereafter, as with the driving control operation illustrated in the FIG. 21, the current latching operation and current writing operation are performed simultaneously and in parallel. Note that the current latching operation is the operation wherein data currents Idata (2i) that are in accordance with the brightness gradation values of the display data for the color pixels PIX of each column for row 2i, supplied from the current driver 130, are received by, and maintained in, the current latching/converting circuits 142b (capacitors CB), described above. Additionally, the current writing operation is an operation for writing to the color pixels PIX of the row (2i−1), for which the pixel reset operation, described above, has been performed, the gradation currents Ipix (2i−1), in accordance with the data currents Idata (2i−1) received and maintained in the current latching/converting circuit 142a during the previous operating period.

Given the present embodiment, the residual charge that is stored in the color pixels for the applicable row and in the data lines can be discharged to perform initialization prior to the current writing operation to the color pixels in the individual rows, and the residual charge that is stored in the current value converting circuit units (current latching/converting circuits) can be discharged to perform initialization prior to the current latching operation in the current value converting circuit unit for each column. Because of this, it is possible to generate, and to supply to each color pixel, a gradation current that has a current value that is appropriate to the display data and to the current efficiency, and possible to achieve a desirable display quality through controlling the occurrence of, for example, non-uniform displays and brightness deviations, and the like.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2007-020396 filed on Jan. 31, 2007 and including specification, claims, drawings and summary. The disclosure of the above Japanese Patent Application is incorporated herein by reference in its entirety.

What is claimed is:

1. A display driving device for driving, based on display data and through a data line, each of a plurality of pixels of different colors, disposed along the data line, connected to the data line and put into a selected state sequentially, comprising:
a current generating circuit that generates and outputs a data current which has a current value corresponding to a brightness designated by the display data; and
a current control unit that receives the data current that is outputted from the current generating circuit; generates a gradation current, based on the received data current and the display characteristics of each display pixel that is put into the selected state, and supplies, to the data line, the generated gradation current, so that the pixel emits light at the designated brightness based on the display characteristics thereof.

2. The display driving device according to claim 1, wherein the current control unit generates, in synchronization with the timing with which each display pixel connected to the data line is put into the selected state, the gradation current in accordance with the characteristics of the display pixel that is in the selected state.

3. The display driving device according to claim 1, wherein the current control unit comprises a current value converting circuit unit, the current value converting circuit unit comprising:
a plurality of current converting circuits, each of the current converting circuits being for respective color, that receives the data current and generates a gradation current in accordance with the display characteristics of the display pixel of the respective color; and
a connection switching circuit that selectively connects, the data line to the current converting circuit corresponding to the color of the display pixel that is put into the selected state, in accordance with the timing of being put into the selected state.

4. The display driving device according to claim 3 comprising a plurality of data lines, wherein:
the display driving device drives a plurality of display pixels connected to the plurality of data lines;
the current value converting circuit unit is provided corresponding to each of the plurality of data lines.

5. The display driving device according to claim 3, wherein:
the display characteristic is the light emitting efficiency;
each of the current converting circuits comprises a current mirror circuit that inputs the data current and outputs the gradation current, the ratio of the current value of the gradation current to the current value of the data current being a specific current ratio;
the current ratio of each current converting circuit is set in accordance with the light emitting efficiency of the display pixel of the corresponding color.

6. The display driving device according to claim 5, wherein:
the current value of the data current is set at a current value that is required in order to cause the display pixel of the color that has the lowest light emitting efficiency, among the light emitting efficiencies of the display pixels of the plurality of colors, to emit light at a desired brightness; and
the current ratio of each of the current converting circuits is set to 1 in a case where the light emitting efficiency of the display pixel of the corresponding color is the lowest; or otherwise set to a value less than 1.

7. The display driving device according to claim 3, wherein each of the current converting circuits comprises a current maintaining circuit that converts the data current into a voltage component and maintaining it as a charge.

8. The display driving device according to claim 7, further comprising a current reset circuit unit that discharges the charge that is maintained in the current maintaining circuit of each of the current converting circuits.

9. The display driving device according to claim 1, further comprising a pixel reset circuit unit that discharges the charges, which correspond to the gradation currents that are supplied to the plurality of display pixels, and which are maintained in the plurality of display pixels.

10. A display device for displaying a color image defined by display data, comprising:
a pixel array in which a plurality of scan lines are arranged in a row direction, a plurality of data lines are arranged in a column direction, a plurality of display pixels are arranged and have a plurality of colors, each of the display pixels is connected to respective one of the scan lines and respective one of the data lines and arranged in a neighborhood of an intersection of the respective scan line and respective data line, and the display pixels of at least two different colors of the plurality of colors are connected to each of the data lines;
a scan driving circuit that sets the plurality of display pixels into a selected state by row;
a current generating circuit that generates and outputs a data current which has a current value corresponding to a brightness designated by the display data; and
a current control unit that: receives the data current that is outputted from the current generating circuit; generates a gradation current, based on the received data current and the display characteristics of each display pixel that is put into the selected state by the scan driving circuit; and supplies, to the data line, the generated gradation current, so that the pixel emits light at the designated brightness based on the display characteristics thereof.

11. The display device according to claim 10, wherein the current control unit generates, synchronized with the timing with which each display pixel connected to the data line is put into the selected state by the scan driving circuit, the gradation current in accordance with the characteristics of the display pixel that is in the selected state.

12. The display device according to claim 10, wherein the current control unit comprises a plurality of current value converting circuits provided one each corresponding to each of the data lines; each of the current value converting circuit units comprising:
current converting circuits, each of the current converting circuits being for respective color, that receives the data current and generates a gradation current in accordance with the display characteristics of the di splay pixel of the respective color; and
a connection switching circuit that selectively connects, the data line to, of the current converting circuits, a current converting circuit corresponding to the color of the display pixel that is put into the selected state, in accordance with the timing of being put into the selected state.

13. The display device according to claim 12, wherein:
the display characteristic is the light emitting efficiency;
each of the current converting circuits comprises a current mirror circuit that inputs the data current and outputs the gradation current, the ratio of the current value of the gradation current to the current value of the data current being a specific current ratio;
the current ratio of each current converting circuit is set in accordance with the light emitting efficiency of the display pixel of the corresponding color.

14. The display device according to claim 13, wherein:
the current value of the data current is set at a current value that is required in order to cause the display pixel of the color that has the lowest light emitting efficiency, among the light emitting efficiencies of the display pixels of the plurality of colors arranged in the pixel array, to emit light at a desired brightness; and
the current ratio in each of the current converting circuits is set to: 1 in a case where the light emitting efficiency of the display pixel of the corresponding color is the lowest; or otherwise set to a value less than 1.

15. The display device according to claim 12, wherein each of the current converting circuits comprises a current maintaining circuit that converts the data current into a voltage component and maintaining it as a charge.

16. The display device according to claim 15, further comprising a current reset circuit unit that discharges the charge that is maintained in the current maintaining circuit of each of the current converting circuits.

17. The display device according to claim 10, further comprising a pixel reset circuit unit that discharges the charges, corresponding to the gradation currents that are supplied to the plurality of display pixels arranged in the pixel array, the charges maintained in the plurality of display pixels.

18. The display device according to claim 10, wherein the plurality of display pixels are arranged in a delta arrangement in the pixel array.

19. The display device according to claim 10, wherein:
each display pixel comprises:
a pixel driving circuit that maintains a charge in accordance with the gradation current that is supplied from the current control unit, and generates a light emitting driving current having a current value depending on the charge; and
a current-controlled light emitting element that performs a light emitting operation at a brightness gradation based on the current value of the light emitting driving current that is supplied from the pixel driving circuit.

20. The display device according to claim 19, wherein the current-controlled light emitting element is an organic electroluminescent element.

21. A driving method for a display device for displaying a color image defined display data, wherein:
the display device comprises a pixel array, in which a plurality of scan lines are arranged in a row direction, a plurality of data lines are arranged in a column direction, plurality of display pixels are arranged and have a plurality of colors, each of the display pixels is connected to respective one of the scan lines and one of the data lines and arranged in a neighborhood of the intersection of the respective scan line and respective data line, and the display pixels of at least two different colors of the plurality of colors are connected to each of the data lines;
the driving method comprises:
an operation of setting the plurality of display pixels into a selected state by row;
an operation of generating and outputting a data current which has a current value corresponding to a brightness designated by the display data in accordance with the timing with which the selected state is set;
an operation of receiving the data current; and
an operation of generating, a gradation current, based on the received data current and the display characteristics of each display pixel that is put into the selected state, and supplying through each data line, to the display pixel that is put into the selected state, the generated gradation current, in such a way that the generating and supplying operation is performed in synchronization with the timing with which the display pixel that is connected to each data line is set into the selected state.

22. The driving method according to claim 21, wherein the operation of generating a gradation current in accordance with a display pixel that is set into the selected state and supplying the generated gradation current through each data line, and the operation of receiving the data current corresponding to the display pixel that will be put into the selected state next, of the display pixel, are performed simultaneously and in parallel within a operating period.

23. The driving method according to claim 21, wherein the operation of receiving the data current corresponding to the display pixel that is set into the selected state, and the operation of generating a gradation current in accordance with the display pixel and supplying the gradation current through each data line, are performed simultaneously and in parallel within a operating period.

24. The driving method according to claim 21, wherein:
the operation of receiving the data current and the operation of generating and supplying the gradation current are performed for each operating period;
the driving method includes an operation of discharging the charge corresponding to the data current that is received during the operating period immediately prior to the operating period, before the operation of receiving the data current.

25. The driving method according to claim 21, wherein:
the operation of receiving the data current and the operation of generating and supplying the gradation current are performed for each operating period;
the driving method includes an operation of discharging the charge, in the display pixel, the charge corresponding to the gradation current that is supplied during the operating period immediately prior to the operating period, before the operation of supplying the gradation current to the display element.
